(19) United States
(12) Patent Application Publication
(10) Pub. No.: US 2009/0034942 A1
(43) Pub. Date: Feb. 5, 2009

(54) INFORMATION RECORDING MEDIUM AND REPRODUCTION CONTROL METHOD

(76) Inventors: Wataru Ikeda, Osaka (JP); Tomoyuki Okada, Nara (JP); Masayuki Kozuka, Osaka (JP)

Correspondence Address: WENDEROTH, LIND & PONACK L.L.P., 2033 K. STREET, NW, SUITE 800, WASHINGTON, DC, 20006, US

(21) Appl. No.: 12/278,310

(22) PCT Filed: Jan. 24, 2007
(86) PCT No.: PCT/JP2007/051074

§ 371 Date: Aug. 5, 2008

(30) Foreign Application Priority Data
Feb. 9, 2006 (JP) 2006-032986

(51) Int. Cl. H04N 5/00

(52) U.S. Cl. 386/126; 386/E05.061

(57) ABSTRACT

Provided is an information recording medium (104) on which a first content and a program are recorded. A reproreproduction apparatus (1) includes: a first storage unit (221) in which a setting value set is stored; an execution unit (206) which executes the program; and a second storage unit (222) which the execution unit (206) can read and write information from/into. The program causes the execution unit (206) to execute steps of: writing (S803) the setting value stored in the first storage unit (221) into the second storage unit (222); comparing (S900) the setting value stored in the first storage unit (221) to the setting value which has been written into the second storage unit (222); and controlling (S920) the reproduction apparatus not to reproduce the first content, in the case where the comparing (S900) indicates that the setting value stored in the first storage unit (221) is different from the setting value which has been written into the second storage unit (222).

### TECHNICAL FIELD

The present invention relates to an information recording medium, such as a Blu-ray Disc Read-Only Memory (BD-ROM), on which contents and a program are recorded, and a reproduction control method of controlling reproduction of the contents.

### BACKGROUND ART

Representative of such information recording medium on which video data is recorded is DVD (hereinafter referred to as “Standard Definition (SD)-DVD”). Conventional DVD is described below.

FIG. 1 is a diagram showing the structure of an SD-DVD. As shown in the bottom of FIG. 1, the DVD disc includes a logical address space in between the read-in area and the read-out area. In the logical address space, volume information of the file system is stored at the top, and application data such as video and audio is stored in the subsequent areas.

A file system is a mechanism for managing data established by International Organization for Standardization (ISO) 9660 and standards such as Universal Disc Format (UDF), and it is a mechanism for representing data on a disc by the unit which is referred to as a directory or file.

Even in the case of a personal computer (PC) used every day, data recorded in a file in a directory in a hard disk is represented on a computer using a file system such as File Allocation Tables (FAT) and NT File System (NTFS), which improves usability.

Both of the UDF and ISO 9660 are used in SD-DVDs as their file systems. Both are put together, and it is referred to as “UDF bridge.” Data recorded on an SD-DVD can be read out also by the file system driver of either UDF or ISO 9660. In addition, DVDs handled here are ROM discs for the package media, and writing is impossible physically.

Data recorded on a DVD can be viewed as directories or files as shown in the upper left of FIG. 1 through a UDF bridge. Immediately below the root directory (“ROOT” in FIG. 1), a directory called “VIDEO_TS” is placed, where application data of the DVD is stored. Application data is stored as plural files. The following kinds of files are considered as main files.

VIDEO_TS.IFO Disc reproduction control information file

VTS_{—}01_{—}0_{—}0.IFO Video title set #1 reproduction control information file

VTS_{—}01_{—}0.VOB Video title set #1 stream file

Two extensions as shown in the above example are defined. “IFO” is an extension indicating that reproduction control information is stored in a file with this extension. “VOB” is an extension indicating that an MPEG stream which is AV data is stored in a file with this extension.

The reproduction control information is, for example, information for realizing interactivity (technique for dynamically changing the state of reproduction according to a user operation) employed for the DVD, as well as information, such as metadata, which is attached to AV data. The reproduction control information of the DVD is called navigation information in general.

The reproduction control information files include “VIDEO_TS.IFO” intended for the management of the entire disc, and “VTS_{—}10_{—}0.IFO” which is the reproduction control information of an individual video title set. Note that plural titles, that is, different films and songs can be recorded in a single DVD disc.

Here, “01” in a filename body shows a video title set number. For example, in the case of video title set #2, the filename body is “VTS_{—}02_{—}0.IFO”.

The upper right of FIG. 1 shows a DVD navigation space in the application layer of the DVD; that is, a logical structure space where details of the above-described reproduction control information are developed. As for the information in “VIDEO_TS.IFO”, the reproduction control information which exists for every “VTS_{—}010_{—}0.IFO” or another video title set, as VIDEO Manager Information (VMGI) is developed in DVD navigation space as Video Title Set Information (VTSI).

Program Chain Information (PGCI) which is information of reproduction sequence referred to as Program Chain (PGC) is described in a VTSI. The PGCI is made up of a group of cells and a kind of programming information called a command.

Cell oneself is information specified as a part of a VOB (which is an abbreviation of Video Object, and which is an MPEG stream) or the entire VOB. Reproducing a cell means reproducing the part of the VOB specified by the cell or the entire VOB.

A command is processed by a DVD virtual machine, and is similar to, for example, lava (registered trademark) Script executed on a browser on which a Webpage is displayed. However, JAVA (registered trademark) script controls a window and a browser (for example, a window of a new browser is opened) in addition to logical operations. Unlike this, a command of DVD is intended only for controlling reproduction of AV titles such as specifying a chapter to be reproduced, in addition to performing logical operations.

A Cell has, as inside information, start and end addresses (logical addresses) of a VOB stored on a disc. A player reads data using the information about the start and end addresses of the VOB described in the Cell, and reproduces the data.

FIG. 2 is a schematic diagram illustrating navigation information embedded in an MPEG stream which is AV data.

Interactivity which is a characteristic of SD-DVDs is realized using not only the navigation information stored on “VIDEO_TS.IFO” and “VTS_{—}01_{—}0.IFO” but also some important information carried in exclusive carriers called navigation packs (also referred to as NV_PCK) multiplexed in a VOB together with video and audio data.

Here, a description is given of a menu screen as a simple example of interactivity. Several buttons appear on a menu screen. For each of the buttons, processing which is executed at the time when the button is selected and entered is defined.

In addition, one button is selected on the menu screen (the button is highlighted by being overlaid with semi-transparent color so as to show a user that the button is being selected), which allows the user to move the highlight indicating a selected button onto any of the buttons positioned upward, downward, leftward, or rightward using the Up, Down, left, or/and Right keys on a remote controller.

Moving the highlight onto the button desired to be selected and entered using the Up, Down, left, or/and Right keys of the remote controller, and entering the button (pressing the enter key) triggers execution of a program of a command associated with the button. In general, the reproduction of a title or a chapter is executed by a command.

The upper left of FIG. 2 shows an overview of the information stored in NV_PCK.NV_PCK includes highlight color information and button information of each button. Highlight color information includes a description of color palette information with which a semi-transparent color used to be overlaid and highlighted in display is specified.

Each button information describes: rectangular area information that is information about the position of each button; move information indicating a move from one button to another button (specification of a destination button corresponding to a user selection of the Up, Down, Right, or/and Left key operation); and button command information (a command which is executed when the button is selected).

As shown in the upper right part of FIG. 2, a highlight on the menu screen is generated as an overlay image. The overlay image is obtained by adding one color in color palette information to rectangular area information of button information. Such overlay image is displayed on the screen, overlaid onto the background image shown in the right part of FIG. 2.

The menu screen of the DVD is obtained in the above-described manner. The reason why a part of navigation data is stored in NV_PCK and embedded in a stream is described below. One of the reason is to perform the following processing which is likely to cause a problem concerning a synchronization timing without causing the problem: dynamically updating menu information in synchronization with a stream, for example, displaying the menu screen only for 5 to 10 minutes while a movie is being reproduced.

In addition, another important reason is to improve user operability, which is realized by storing information for supporting trick-play in NV_PCK so that AV data can be decoded and reproduced smoothly even in the case of special reproduction such as fast forwarding and rewinding in reproduction of the DVD.

FIG. 3 is a schematic diagram showing the structure of a VOB in a DVD. As shown in the diagram, data such as video, audio, subtitles ((1) of FIG. 3) are stored in packets and packs ((2) of FIG. 3) according to MPEG system (ISO/IEC13818-1) standards, and the respective packets and packs are multiplexed in a single MPEG program stream ((3) of FIG. 3).

NV_PCK including button commands for realizing interactivity is multiplexed together as described above.

Data multiplexed in the MPEG system is characterized in that, while each data which is multiplexed forms a bit string based on the decoding order, the data which is multiplexed; that is, video data, audio data, and subtitle data are not necessarily arranged in the corresponding bit strings in the order of reproduction or decoding.

This is attributable to the fact that a decoder model for MPEG system streams (generally referred to as a “System Target Decoder” or an “STD” (refer to FIG. 3 (4)) has decoder buffers corresponding to the respective elementary streams obtained by demultiplexing the multiplexed data, and such demultiplexed data are temporarily accumulated in the respective decoder buffers until the time of decoding.

The respective decoder buffers have different sizes for the corresponding elementary streams; 232 kB for video, 4 kB for audio, and 52 kB for subtitles.

Due to this, timings for data entry to the respective decoder buffers vary for individual elementary streams. This generates gaps in the order according to which such bit streams are formed as MPEG system streams and in the timings at which they are displayed (decoded).

In other words, the subtitle data multiplexed together with the video data is not necessarily decoded at the same timing as the timing at which the video data is decoded.

The above-described techniques for DVDs are described in Patent Reference 1.

### Patent Reference 1: Japanese Patent No. 2813245 Publication

### DISCLOSURE OF INVENTION

### Problems that Invention is to Solve

Here, in each DVD video player (hereinafter, referred to simply as a “DVD player”), one region code that is information for identifying a region to which the DVD player is distributed is recorded as a setting value. This region code is managed by the DVD player (including a DVD drive).

It should be noted that the “region to which the DVD player is distributed” roughly corresponds to a region where the DVD player is used. For example, DVD players which are to be distributed to Japan are manufactured for Japanese markets, then sold in Japan, and used in Japan for most of cases.

Moreover, in a DVD on which a content such as a movie is recorded, one or more region codes are set. If any one of the region codes matches the region code of the DVD player, the content is allowed to be reproduced.

This means that such a region code can restrict a region at which reproduction of a content recorded on a DVD is permitted.

For example, a region code “2” is stored in DVD players to be sold in Japan, while a region code “1” is stored in DVD players to be sold in North American countries.

Therefore, DVD players sold in Japan cannot reproduce contents which are recorded on DVDs sold in North American countries.

However, there are DVD players in which no region code is set, or all region codes are set. In other words, there are unauthorized DVD players of region free. This means that there are DVD players which can reproduce all DVDs regardless of region codes set in the DVDs.

Here, it is assumed that a content provider (a creator of a content, or a distributor of information recording mediums on which the content is recorded, for example) manufactures DVDs for plural regions each having a different region code, in order to gradually delay a starting time of distribution of the content for the respective regions.

Under the above assumption, the above-mentioned region-free DVD player can reproduce the content, whichever the region for which the DVD is manufactured is.

Therefore, the content provider cannot control regions to be provided and a time for providing the content, for such unauthorized DVD players.

However, realization of the control is vital for marketing strategy, copyright protection, distribution of contents according to distributed regions, and the like, which are also creative activities of the content provider.

In short, there is a problem of a high possibility that the above marketing strategy or the like scheduled by the content provider cannot be carried out properly because of the above-mentioned unauthorized DVD players.

It should be noted that, in BD-ROM players, a region code is stored as a setting value in a register and processed by a program. For BD-ROM players, setting of region free is prohibited. Thereby, in principal, the above-explained problem does not occur for BD-ROM players.

In addition, it is possible to switch between contents to be reproduced, according to a region code stored in a BD-ROM player.

Here, it is assumed that a region code corresponding to Japan is “A”, and a region code corresponding to Germany is “B”.

Under the assumption, if a BD-ROM has a Japanese-language version and a German-language version of a movie, region codes “A” and “B” are recorded on the BD-ROM, for example. The region code “A” is associated with the Japanese-language version, and the region code “B” is associated with the German-language version.

When a BD-ROM player sold in Japan reproduces this BD-ROM, the BD-ROM player reads out content data of the Japanese-language version in association with the region code “A” corresponding to Japan, and reproduces the readout content data.

On the other hand, when a BD-ROM player sold in Germany reproduces this BD-ROM, the BD-ROM player reads out content data of the German-language version in association with the region code “B” corresponding to Germany, and reproduces the readout content data.

In this way, BD-ROM players can switch between contents to be reproduced, according to a region, by using a region code recorded on a BD-ROM.

The content switching is actually realized when the BD-ROM player executes a program recorded on the BD-ROM.

Unfortunately, it is still possible to manufacture unauthorized BD-ROM players which can switch between region codes as a user desires by user's setting. Furthermore, unauthorized modification for changing an initially setting region code to another value is also possible. Also, there is a possibility that a region code is changed due to some trouble in a BD-ROM player.

There is no way content providers can prevent manufacturing of such unauthorized BD-ROM players, occurrence of troubles in BD-ROM players, and the like. Therefore, reproduction of BD-ROMs by these BD-ROM players can not prevented, and contents are reproduced against expectation of the content providers.

In other words, at present, there is no adequate circumstances where intentions of content provides are reflected and contents are reproduced appropriately according to setting values such as region codes.

Thus, the present invention overcomes the conventional problems as described above. It is an object of the present invention to provide an information recording medium and a reproduction control method by which a reproduction apparatus reproduces a content properly based on intension of a provider of the content.

### Means to Solve the Problems

In accordance with an aspect of the present invention for achieving the above object, there has been provided an information recording medium on which [i] a first content that can be reproduced by a reproduction apparatus and [ii] a program that is executed by the reproduction apparatus are recorded: wherein the reproduction apparatus including [i] a first storage unit in which a setting value set for the reproduction apparatus is stored, [ii] an execution unit configured to execute the program, and [iii] a second storage unit where the execution unit can read and write information, and the program causes the execution unit to execute steps of: writing the setting value stored in the first storage unit into the second storage unit; comparing the setting value stored in the first storage unit to the setting value which has been written into the second storage unit; and controlling the reproduction apparatus not to reproduce the first content, in the case where the comparing indicates that the setting value stored in the first storage unit is different from the setting value which has been written into the second storage unit.

Thereby, the reproduction apparatus, which attempts to reproduce the first content recorded on the information recording medium of the present invention, judges whether or not the setting value of the reproduction apparatus has not been changed from a previously setting value, and if the setting value has been changed, then does not reproduce the first content.

As a result, the present invention can prevent the first content from being reproduced based on such a changed, inappropriate setting value, when the setting value which cannot inherently be changed has been changed from the previously setting value.

In addition, the above-described controlling is realized by the program recorded on the information recording medium, and the program can be created by a provider of the content. Therefore, the content can be reproduced properly based on intention of the provider of the content.

The setting value may be a region code which is information for identifying a region to which the reproduction apparatus is to be distributed. In the controlling, the reproduction apparatus may be controlled to reproduce the first content, in the case where the comparing indicates that the region code stored in the first storage unit is same as a region code which has been written into the second storage unit and the first content corresponds to the region code stored in the first storage unit.

Thereby, when the region code stored in the reproduction apparatus has not been changed, a content in association with the region code is reproduced. This means that reproduction of the first content is properly controlled according to a region to which the reproduction apparatus belongs.

In the information recording medium, the program may cause the execution unit to execute a further step of confirming whether or not any setting value is stored in the second storage unit, the confirming being performed prior to the writing of the setting value into the second storage unit, and wherein in the writing of the setting value, the setting value stored in the first storage unit is written into the second storage unit, in the case where the confirming indicates that no setting value is stored in the second storage unit, and in the comparing, the setting value stored in the second storage unit is compared to the setting value stored in the first storage unit, in the case where the confirming indicates that any setting value is stored in the second storage unit, the setting value stored in the second storage unit having been written into the second storage unit.

Thereby, when any setting value has already been stored in the second storage unit, the setting value is a value which has been previously written into the second storage unit. Therefore, the setting value is compared with the setting value stored in the first storage unit.

In the writing of the setting value, the setting value stored in the first storage unit may be not written into the second storage unit, in the case where the confirming indicates that any setting value is stored in the second storage unit.

This means that writing of the setting value into the second storage unit, in other words, copying of the setting value stored in the first storage unit into the second storage unit is performed only when no setting value is stored in the second storage unit.

The setting value stored in the first storage unit may be a predetermined possible value, the program may cause the execution unit to execute a further step of judging whether or not the setting value stored in the first storage unit is the predetermined possible value, and in the controlling, the reproduction apparatus may be controlled not to reproduce the first content, in the case where the comparing indicates that the setting value stored in the first storage unit is not the predetermined possible value.

Thereby, not only when the setting value stored in the reproduction apparatus has been changed, but also when the setting value is not a regulated value, it is possible to restrict reproduction of the first content. This means that the present invention can prevent the first content from being reproduced based on a setting value which is not regulated nor authorized.

Moreover, the present invention can be realized also as a reproduction apparatus which is able to reproduce the first content, reads a program from the information recording medium of the present invention, and executes the program.

Furthermore, the present invention can be realized also as: a reproduction control method having characteristic steps performed by the reproduction apparatus; a program causing a computer to execute the steps; and the like. Such a program can be distributed on storage media such as CD-ROMs, and via transmission media such as the Internet.

### EFFECTS OF THE INVENTION

The present invention can provide an information recording medium and a reproduction control method by which a reproduction apparatus reproduces a content properly based on intension of a provider of the content.

### BRIEF DESCRIPTION OF DRAWINGS

FIG. 1 is a diagram showing the structure of an SD-DVD.

FIG. 2 is a schematic diagram illustrating navigation information embedded in an MPEG stream which is AV data.

FIG. 3 is a schematic diagram showing the structure of a VOB in a DVD.

FIG. 4 is a diagram showing a data hierarchy of a BD-ROM.

FIG. 5 is a diagram showing the structure of logical data stored on a BD-ROM.

FIG. 6 is a schematic diagram showing the basic structure of a BD-ROM player which reproduces a BD-ROM.

FIG. 7 is a detailed block diagram showing the structure of the player shown in FIG. 6.

FIG. 8 is a diagram showing application space of a BD-ROM.

FIG. 9 is a diagram showing the structure of an MPEG stream (VOB).

FIG. 10 is a diagram showing the structure of a pack in an MPEG stream.

FIG. 11 is a diagram illustrating the relationship between AV data and the structure of a player.

FIG. 12 is a diagram illustrating a model for continuous supply of VOB data using a track buffer.

FIG. 13 is a diagram showing the internal structure of a VOB management information file.

FIG. 14 is a diagram illustrating the details of each VOBU information.

FIG. 15 is a diagram illustrating a method for obtaining address information using a time map.

FIG. 16 is a diagram showing the structure of a playlist.

FIG. 17 is a diagram showing the structure of an event handler table.

FIG. 18 is a diagram showing the structure of BD.INFO which is the entire BD-ROM information.

FIG. 19 is a diagram showing the structure of an event handler table.

FIG. 20 is a diagram showing an example of a time event.

FIG. 21 is a diagram showing an example of a user event triggered by menu operation performed by a user.

FIG. 22 is a diagram showing an example of a global event.

FIG. 23 is a diagram illustrating the functional structure of a program processor.

FIG. 24 is a diagram showing a list of system parameters (SPRMs).

FIG. 25 is a diagram showing an example of a program in an event handler concerning control of a menu screen having two selection buttons.

FIG. 26 is a diagram showing an example of a program in an event handler concerning a user event for menu selection.

FIG. 27 is a flowchart showing a flow of basic processing for reproducing AV data in a BD-ROM player.

FIG. 28 is a flowchart showing a flow of processing from the start of reproducing a playlist in a BD-ROM player to the end of reproducing VOBs.

FIG. 29(A) is a flowchart showing a flow of processing concerning a time event in a BD-ROM player, and FIG. 29(B) is a flowchart showing a flow of processing concerning a user event in the BD-ROM player.

FIG. 30 is a flowchart showing a flow of processing subtitle data in a BD-ROM player.

FIG. 31 is a functional block diagram showing a main functional structure of a BD-ROM player according to a second embodiment.

FIG. 32 is a diagram showing examples of region codes.

FIG. 33 is a schematic diagram showing a program which switches between contents to be reproduced, according to a region code of the BD-ROM player.

FIG. 34 is a flowchart of processing performed by the BD-ROM player based on a BD reproduction program according to the second embodiment.

FIG. 35 is a flowchart showing flows of invariance judgment processing and reproduction control processing shown in FIG. 34.

FIG. 36 is a flowchart showing a flow of processing of the BD reproduction program for judging authorization of a region code and controlling the BD-ROM player based on the judgment result.

FIG. 37 is a flowchart showing an example of a processing flow of the BD reproduction program in the case where the authorization judgment processing for the region code is performed before the invariance judgment processing for the region code.

FIG. 38 is a flowchart showing an example of a processing flow of the BD reproduction program in the case where the authorization judgment processing for the region code is performed in the invariance judgment processing for the region code.

### NUMERICAL REFERENCES

1 BD-ROM player
104 BD-ROM
202 optical pickup
203 program storage memory
204 management information storage memory
205 AV storage memory
206 program execution unit
207 management information processing unit
208 presentation processing unit
209 image plane
210 video plane
211 overlay processing unit
220 reproduction unit
221 first storage unit
222 second storage unit
302 program processor
303 UO manager
305 scenario processor
306 presentation controller
307 clock
308 image memory
309 track buffer
310 demultiplexer
311 image processor
312 video processor
313 sound processor
317 drive controller
S801 confirmation step
S802 reading step
S803 writing step
S900 invariance judgment processing
S910 authorization judgment processing
S920 reproduction control step

### BEST MODE FOR CARRYING OUT THE INVENTION

Preferred embodiments for carrying out the present invention will be described below with reference to the attached drawings.

The Second Embodiment is the embodiment closest to the invention of claim 1 of the present application. However, for easier understanding, the First Embodiment having basic structures of an information recording medium in the Second Embodiment will be described first.

### FIRST EMBODIMENT

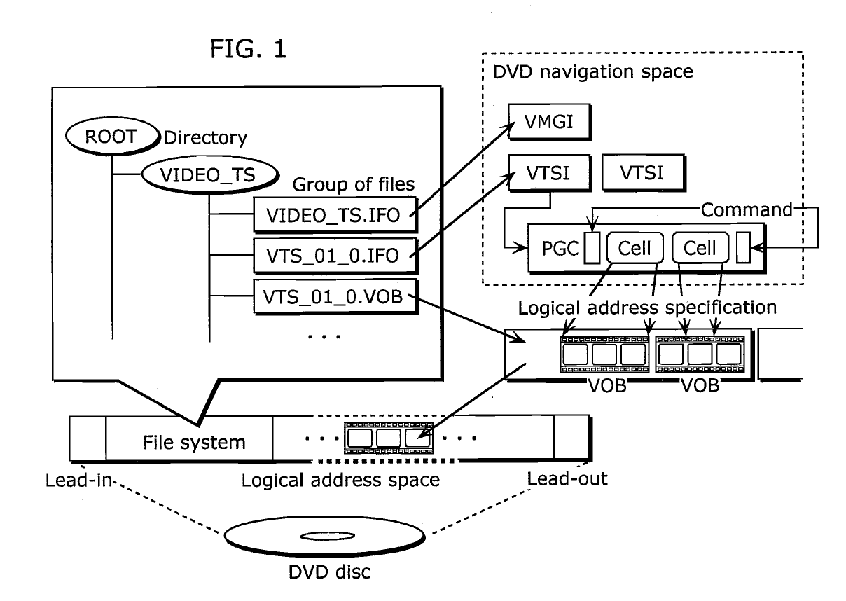

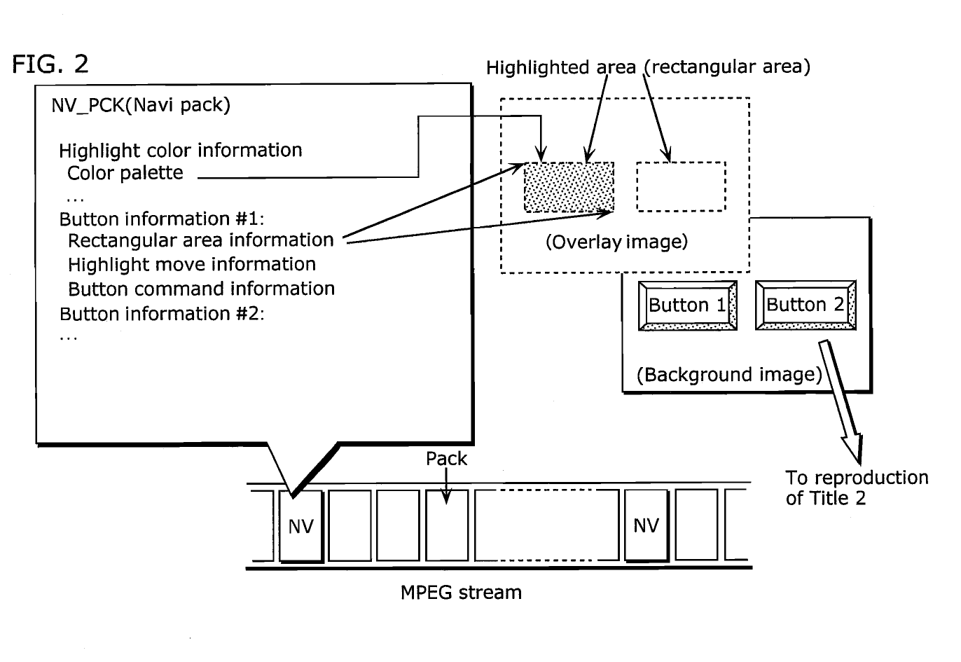

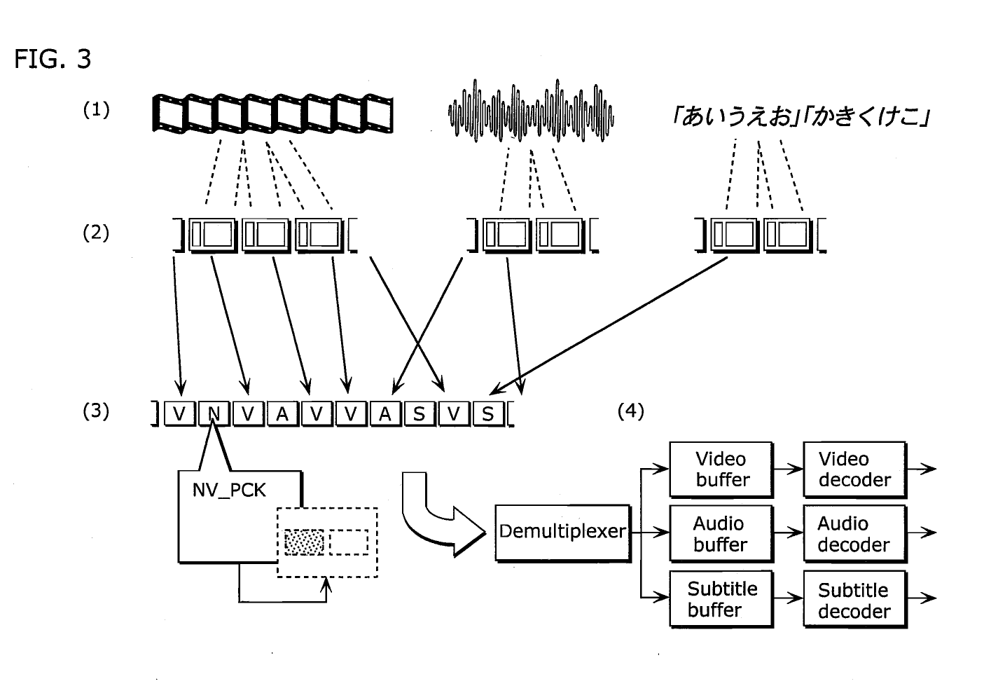

Firstly, basic structures and processing of a BD-ROM and a BD-ROM player which reproduces the BD-ROM are described with reference to FIGS. 1 to 30.

(Logical Data Structure on Disc)

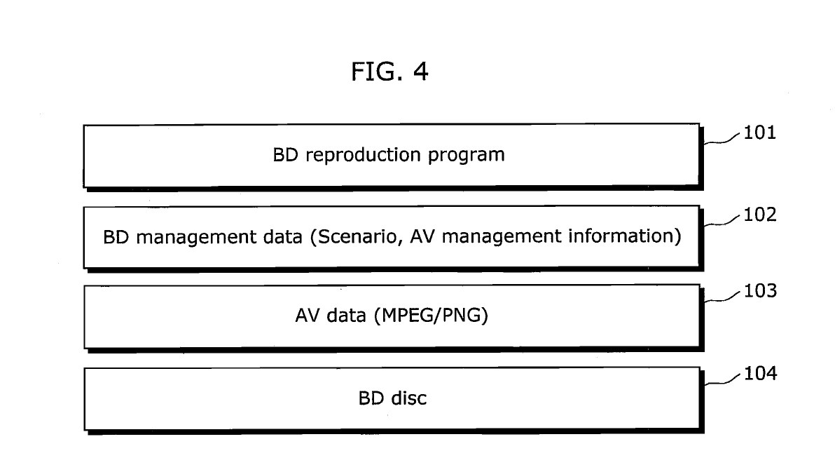

FIG. 4 is a diagram showing a data hierarchy of a BD-ROM.

As shown in FIG. 4, stored on the BD-ROM 104 are: AV data 103; BD management information 102 including AV data management information, an AV reproduction sequence, and the like; and a BD reproduction program 101 for realizing interactivity.

A description is given of the BD-ROM focusing on an AV application for reproducing AV contents such as movies in this embodiment, but it should be noted that it is possible to use the BD-ROM as a recording medium for computers as well as a CD-ROM and a DVD-ROM.

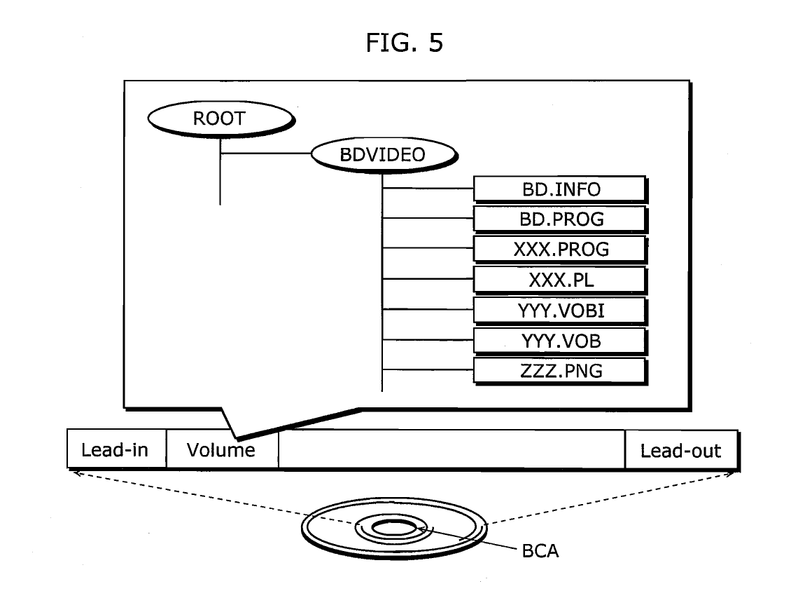

FIG. 5 is a diagram showing the structure of logical data stored on the BD-ROM 104. As in the case of other optical discs such as DVDs and CDs, the BD-ROM 104 has storage areas that are spirally formed in a direction from the inner radius toward the outer radius, as well as a logical address space for storing logical data in between the read-in area at the inner radius and the read-out area at the outer radius.

In addition, the inward of read-in includes a special area that can be read only by a drive as referred to as Burst Cutting Area (BCA). Since this area cannot be read from an application, it is used, for example, for copyright protection technique.

In the logical address space, file system information (volume) is stored at the top of the space, and application data such as video data is stored in the subsequent areas. The file system is a mechanism for managing data specified according to standards such as the UDF and the ISO 9660, as described in the BACKGROUND ART. With the mechanism, it is possible to read logical data stored in the same way as a normal PC using a directory and a file structure.

In this embodiment, according to the structures of the directories and files on the BD-ROM 104, a BDVIDEO directory is located immediately below the root directory (ROOT). Recorded in this directory are: AV data and data such as management information data recorded onto the BD-ROM (BD reproduction program 101, BD management information 102, and AV data 103 which are shown in FIG. 4).

Seven types of files described below are stored under the BDVIDEO directory.

BD.INFO (Fixed File Name)

The file, which forms a part of the “BD management information”, is a file on which information related to the entire BD-ROM is stored. This is the first file which is read out by a BD-ROM player.

BD.PROG (Fixed File Name)

The file, which forms a part of the “BD reproduction program”, is a file on which information related to the entire BD-ROM is stored.

XXX.PL (Variable “XXX” with Fixed Extender “PL”)

The file, which forms a part of the “BD management information”, is a file on which playlist (PlayList) information storing a scenario is stored. This file is included in each playlist.

XXX.PROG (Variable “XXX” with Fixed Extender “PROG”)

The file, which forms a part of the “BD reproduction program”, is a file on which a program for each playlist is stored. The association with the playlist is identified by the file body name (including the same “XXX”.)

YYY.VOB (Variable “YYY” with Fixed Extender “VOB”)

The file, which forms a part of the “AV data”, is a file on which the VOB (which is the same as the one described in “BACKGROUND OF THE INVENTION”) is stored. One VOB corresponds to one file.

YYY.VOBI (Variable “YYY“ ” with Fixed Extender “VOBI”)

The file, which forms a part of the “BD management information”, is a file on which management information related to a VOB which is AV data is stored. The association with VOB is identified by the file body name (including the same “YYY”).

ZZZ.PNG (Variable “ZZZ” with Fixed Extender “PNG”)

The file, which forms a part of the “AV data”, is an image file having a PNG format for constructing subtitles and a menu screen (the PNG is an image format standardized by the World Wide Web Consortium (W3C), and is pronounced “ping”.) One PNG image corresponds to one file.

(Structure of Player)

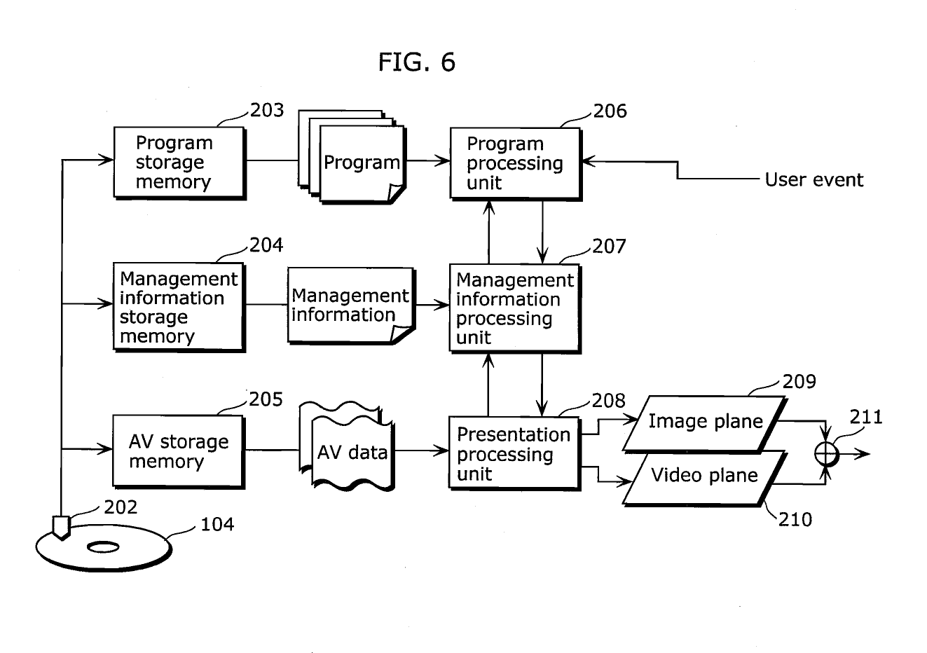

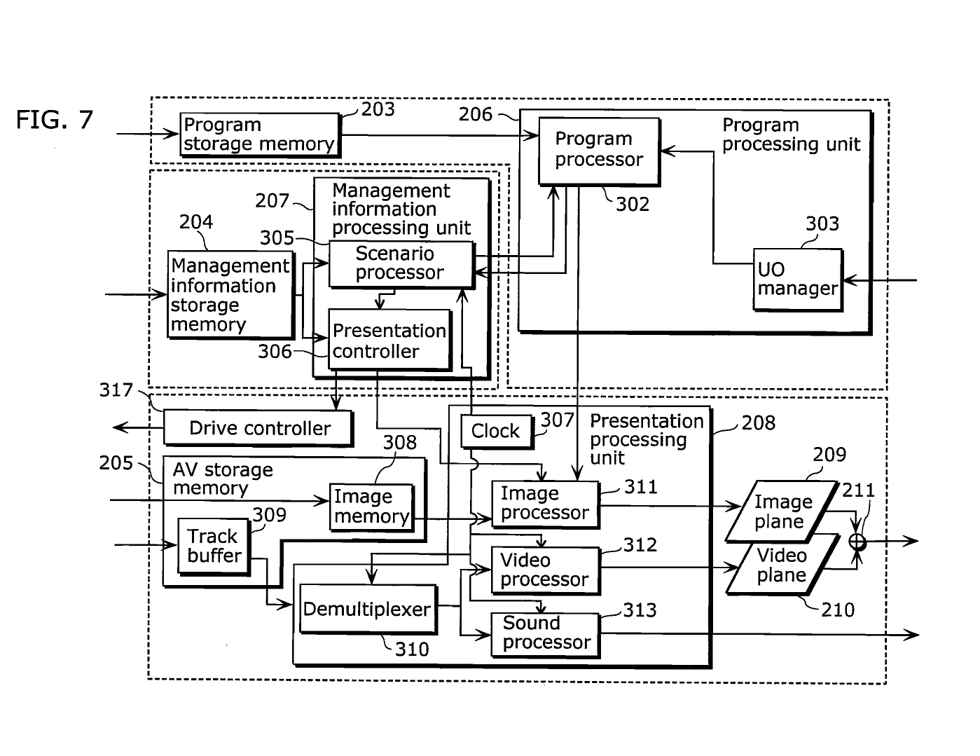

Next, a description is given of the structure of a player which reproduces the above-described BD-ROM 104 with reference to FIG. 6 and FIG. 7.

FIG. 6 is a schematic diagram showing the basic structure of a BD-ROM player which reproduces a BD-ROM 104.

In the BD-ROM player shown in FIG. 6, data in the BD-ROM 104 is read through an optical pickup 202. Each read data is recorded in an exclusive memory depending on the type of such data.

The BD reproduction program (“BD.PROG” or an “XXX.PROG” file) is stored in a program storage memory 203, the BD management information (a “BD.INFO”, “XXX.PL” or “YYY.VOBI” file) is stored in a management information storage memory 204, and AV data (a “YYY.VOB” or “ZZZ.PNG” file) is stored in an AV storage memory 205.

The BD reproduction program stored in the program storage memory 203 is processed by a program execution unit 206. The BD management information stored in the management information storage memory 204 is processed by a management information processing unit 207.

The AV data stored in the AV storage memory 205 is processed by a presentation processing unit 208.

The program execution unit 206 receives, from the management information processing unit 207, information about a playlist to be reproduced and event information such as timing for executing a program, and then executes the program. In addition, it is possible to dynamically exchange playlists to be reproduced by a program. Such exchange can be achieved by transmitting an instruction for reproducing a playlist to be reproduced to the management information processing unit 207.

The program execution unit 206 receives an event from the user; that is, a request made by the user using a remote controller, and if there is the program corresponding to such event from the user, executes the program.

The management information processing unit 207 receives an instruction from the program execution unit 206, and analyzes the corresponding playlist and management information of a VOB corresponding to the playlist. Furthermore, the management information processing unit 207 instructs the presentation processing unit 208 to reproduce AV data to be reproduced.

Furthermore, the management information processing unit 207 receives reference time information from the presentation processing unit 208, and instructs the presentation processing unit 208 to end the reproduction of the AV data based on the reference time information. Further, the management information processing unit 207 generates an event, used to give an instruction to the program execution unit 206, indicating the timing for executing the program.

The presentation processing unit 208, which has decoders corresponding to video, audio, and subtitles respectively, decodes and outputs the AV data according to an instruction from the management information processing unit 207. Video data and subtitle data are decoded and drawn in the plains for exclusive use of the respective data.

More specifically, video data is drawn in a video plane 210, and image data such as subtitle data is drawn in an image plane 209. The images drawn onto the video plane 210 and image plane 209 are overlaid by an overlay processing unit 211, and the overlay images are outputted to a display device such as a television.

As shown in FIG. 6, a BD-ROM player is structured in accordance with the structure of the data stored in a BD-ROM 104 shown in FIG. 4.

FIG. 7 is a block diagram showing in detail the structure of the player shown in FIG. 6. The associations between structural parts shown in FIG. 6 and the structural parts shown in FIG. 7 are shown below.

The AV storage memory 205 corresponds to an image memory 308 and a track buffer 309. The program execution unit 206 corresponds to a program processor 302 and a User Operation (UO) manager 303. The management information processing unit 207 corresponds to a scenario processor 305 and a presentation controller 306. The presentation processing unit 208 corresponds to a clock 307, a demultiplexer 310, an image processor 311, a video processor 312, and a sound processor 313.

The VOB data (MPEG stream) read from the BD-ROM 104 is recorded in the track buffer 309 and image data (PNG) is recorded in the image memory 308.

The demultiplexer 310 extracts the VOB data stored in the track buffer 309 based on the time indicated by the clock 307. Further, the demultiplexer 310 sends the video data included in the VOB data to the video processor 312, and sends the audio data to the sound processor 313.

The video processor 312 and the sound processor 313 are each structured with a decoder buffer and a decoder, as defined by the MPEG system standard. In other words, the video data and audio data inputted from the demultiplexer 310 are temporarily stored in the respective decoder buffers and decoded by the respectively corresponding decoders according to the time indicated by the clock 307.

The PNG data stored in the image memory 308 is processed using two methods described below. First, in the case where the PNG data is subtitle data, the presentation controller 306 gives an instruction about decoding timing. A scenario processor 305 temporarily receives time information from a clock 307, and at the (starting and ending) time of displaying subtitles, it instructs the presentation controller 306 to start or end display of subtitles so that subtitles are displayed appropriately.

The image processor 311, upon receipt of an instruction from the presentation controller 306 to decode and display the image data, reads out the corresponding PNG data from the image memory 308, decodes it, and draws the decoded data onto the image plane 209.

In addition, in the case where the PNG data is for menu screen, the program processor 302 gives an instruction about decoding timing. Timing at which the program processor 302 gives an instruction to decode the image data depends on BD program processed by the program processor 302, and thus it is not simply determined.

As described with reference to FIG. 6, the image data and video data are decoded and drawn respectively onto the image plane 209 and the video plane 210, and are overlaid by the overlay processing unit 211 and outputted.

Management information (a scenario, AV management information) read by the BD-ROM 104 is stored in a management information storage memory 204, but scenario information (“BD.INFO” and “XXX.PL”) is read and processed by the scenario processor 305. In addition, AV management information (a “YYY.VOBI” file) is read and processed by the presentation controller 306.

The scenario processor 305 analyzes information of a playlist, indicates, to the presentation controller 306, the VOB referred to using the playlist and the reproduction position of the VOB. The presentation controller 306 analyzes management information (“YYY.VOBI”) of the current VOB to be reproduced, and instructs the drive controller 317 to read the current VOB.

According to the instruction from the presentation controller 306, the drive controller 317 reads out the current AV data by moving the optical pick-up 202. The read AV data is stored into the image memory 308 or the track buffer 309, as described above.

The scenario processor 305 monitors the time indicated by the clock 307, and outputs, to the program processor 302, an event at the timing which is set in the management information.

The BD program (“BD.PROG” or “XXX.PROG”) stored in the program storage memory 203 is processed by the program processor 302. The program processor 302 processes the BD program in the case where an event is sent from the scenario processor 305 or where an event is sent from the UO manager 303.

The UO manager 303 generates an event corresponding to the request and sends it to the program processor 302 in the case where a request is sent from the user using a remote control key.

The respective structural units operate in this way in the reproduction of a BD-ROM.

(Application Space)

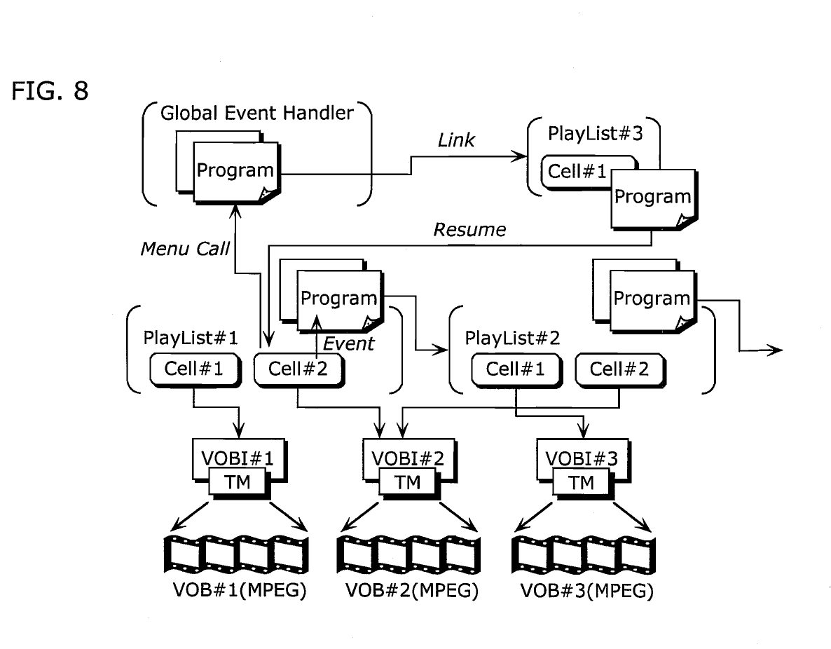

FIG. 8 is a diagram showing application space of a BD-ROM.

In the application space on the BD-ROM, a playlist (PLayList) serves as a unit of reproduction. Each playlist includes a static scenario structured with a reproduction sequence of cells (Cell) and a dynamic scenario described by the program.

As far as no dynamic scenario described by the program is present, the respective cells in the playlist are reproduced in sequence, and the reproduction of the cells in the playlist ends at the time when all the cells are reproduced.

In contrast, such program makes it possible to dynamically change descriptions for reproduction in playlists irrespective of playlists, and the object to be reproduced depending on selections made by users or statuses of players. Typical examples include dynamic modification of an object to be reproduced through a menu screen. In the case of a BD-ROM, a menu is a scenario to be reproduced through selection made by a user; that is, one of the functional elements for dynamically selecting a playlist.

The program here refers to an event handler that is executed by a time event or a user event.

Time events are generated based on time information embedded in a playlist. Time events includes an event sent from the scenario processor 305 to the program processor 302 as described with reference to FIG. 7. When a time event is issued, the program processor 302 executes an event handler associated with the corresponding identifier (ID).

As described above, a program to be executed can indicate reproduction of another playlist. In this case, the reproduction of the playlist which is currently being reproduced is stopped and instead, a transition is made to reproduce the indicated playlist.

User events are generated through remote key operations by the user. Such user events are categorized roughly into two types. User events of a first type are menu selection events that are generated by operating cursor keys (the Up, Down, Right, Left keys and the “Determination” key).

Event handlers corresponding to menu selection events are effective only during a limited time duration indicated in a playlist. In other words, as information of a playlist, effective time duration of an individual event handler is set. When the Up, Down, Right, Left keys and the “Determination” key on the remote controller are pressed, a search is made for an effective event handler. In the case where an effective event handler exists, the event handler is executed. In the case where there is no effective event handler, this menu selection event is ignored.

User events of a second type are menu call events that are generated by operating the “Menu” key. When a menu screen call event is generated, a global event handler is called.

The global event handler is always effective without depending on any playlists. With this function, it is possible to implement a menu call of a DVD. Implementation of this menu call makes it possible to call audio data or subtitle data during the reproduction of a title, and resume the reproduction of the title at the point where the audio data or subtitle data is suspended and changed, after the change.

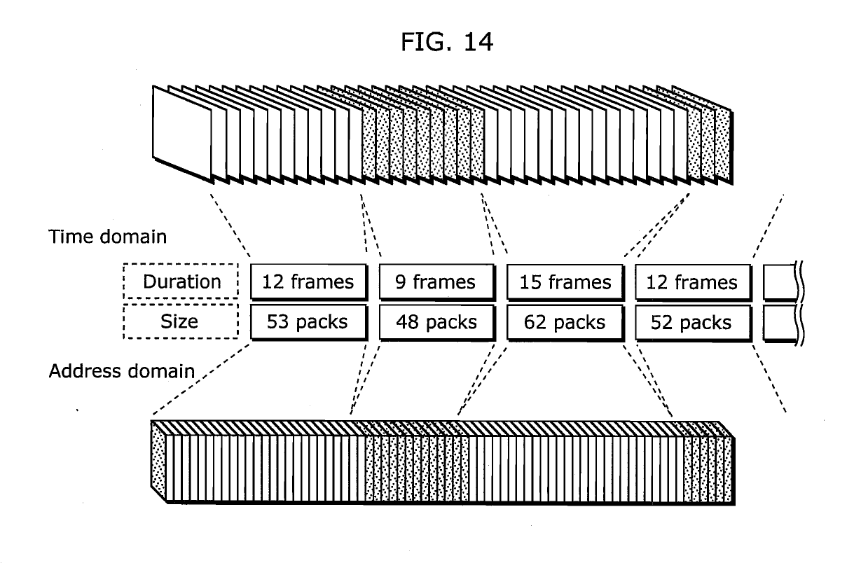

A cell (Cell), which is a unit constituting a static scenario in a playlist, represents a part of the reproduction segments in a VOB (MPEG stream) or the entire reproduction segments. Each cell includes the reproduction segments in a VOB as information about reproduction start time and reproduction end time. VOB management information (VOBI) paired with an individual VOB has a time map (TimeMap or TM) which makes it possible to derive reading start address and reading end address within a VOB (that is, within “YYY.VOB” which is a current file to be reproduced) based on the time map. Time map is described in detail later with reference to FIG. 14.

(Details about Vob)

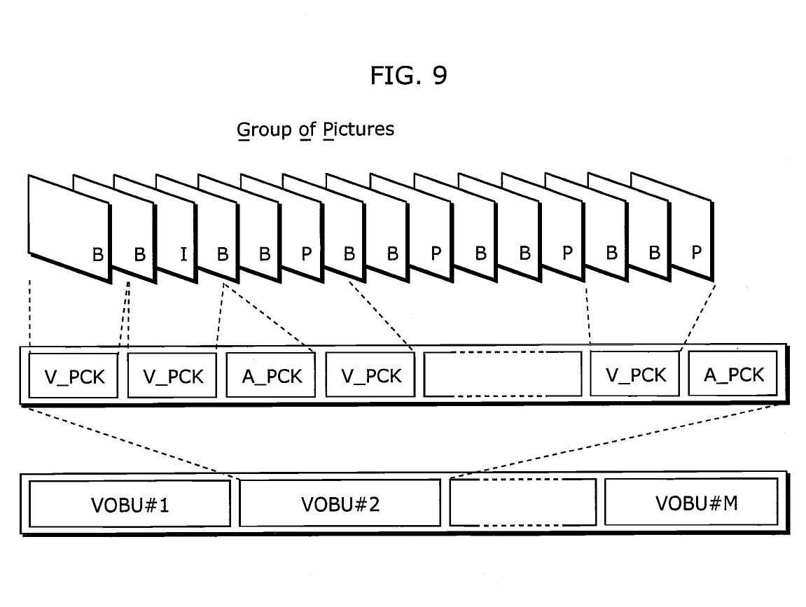

FIG. 9 is a diagram showing the structure of an MIPEG stream (VOB) in this embodiment. As shown in FIG. 9, a VOB is structured with plural Video Object Units (VOBUs). VOBU is a unit based on Group Of Pictures (GOP) in an MPEG video stream, and it is one reproduction unit as a multiplexed stream in which audio data is included.

The reproduction time of a VOBU may be 0.4 to 1.0 second, and usually, it is 0.5 second. This is because the structure of a GOP in MPEG is usually 15 frames per second (in the case of NTSC). Each VOBU includes video packs (V_PCK) which is video data and audio packs (A_PCK) which is audio data. Each pack is structured with one sector, and in this embodiment, it has a data size of 2 kB.

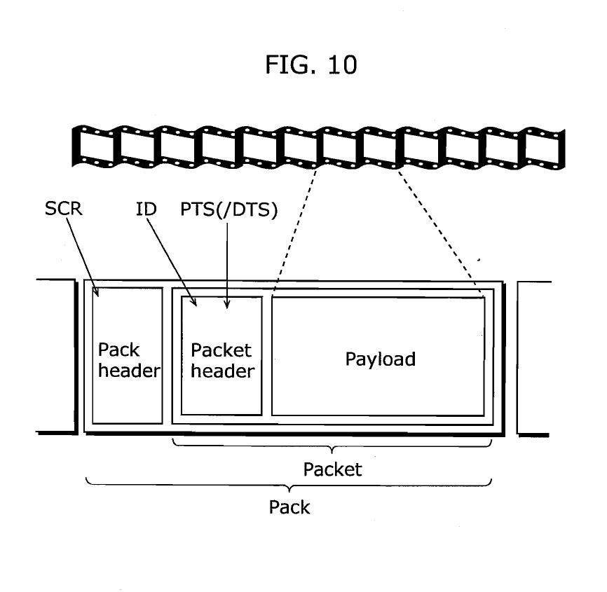

FIG. 10 is a diagram showing the structure of a pack in an MPEG stream.

As shown in FIG. 10, elementary data such as video data and audio data are inputted in a data storage area, of a packet, which is referred to as payload sequentially from the top. A packet header is attached to a payload to form a packet.

The packet header includes: (i) an ID (stream_id) for identifying (i-1) to which stream the data stored in the payload belongs, (i-2) whether the data is video data or audio data, and (i-3) in the case where there are plural video data and audio data for plural streams, to which stream each data belongs; (ii) a Decode Time Stamp (DTS) which is a time stamp indicating decoding time information of the payload; and (iii) a Presentation Time Stamp (PTS) which is a time stamp indicating display time information of the payload.

Not all packet headers include a PTS and a DTS, and a rule for recording a PTS and DTS is defined in the MPEG standard. Details of such rule are described in the MPEG system (ISO/IEC 13818-1) standard, and therefore no description is given.

The packet, when further added with a header (Pack Header), makes up a pack. Stored in such header is a System Clock Reference (SCR) which is a time stamp indicating when such pack passes through the demultiplexer 310 and are inputted to a decoder buffer corresponding to an elementary stream.

(Interleaved Storage of VOB)

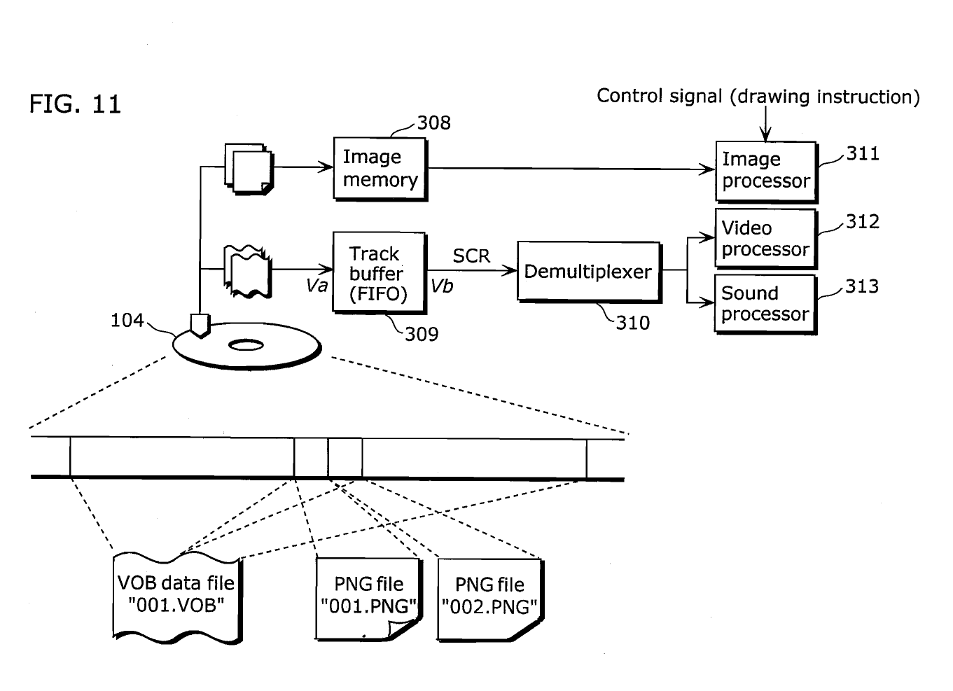

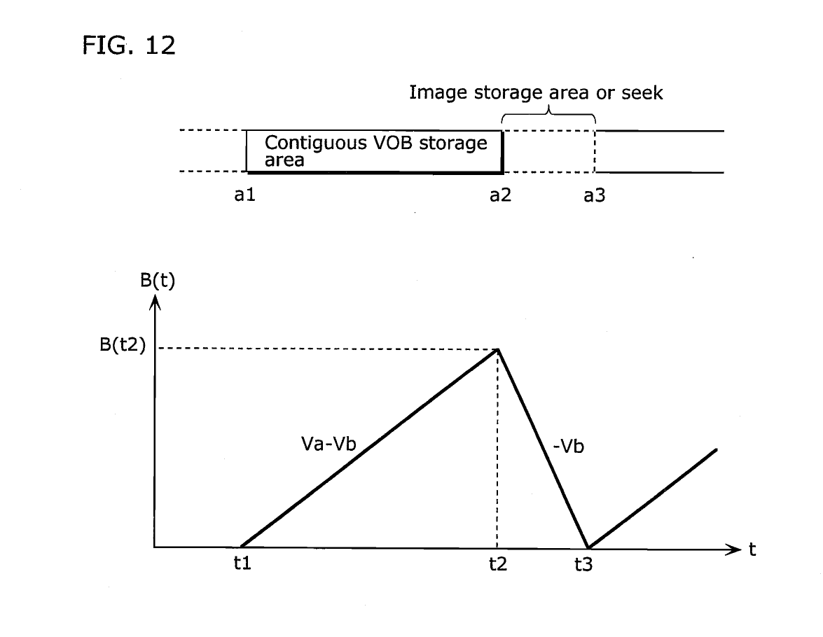

Next, a description is given of interleaved storage of a VOB file with reference to FIG. 11 and FIG. 12.

FIG. 11 is a diagram illustrating the relationship between AV data and the structure of a BD-ROM player.

The upper part of FIG. 11 shows a part of the structure of the player described in FIG. 7. As shown in the diagram, a VOB which is an MPEG stream recorded on a BD-ROM is inputted to the track buffer 309 through an optical pickup 202, and a PNG which is an image data recorded on the BD-ROM is inputted to the image memory 308.

The track buffer 309 is for First-In First-Out (FIFO), and thus inputted VOB data are sent to a demultiplexer 310 in the input order. At this time, each pack is extracted from the track buffer 309 according to the SCR described above, and then sent to the video processor 312 or the sound processor 313 through the demultiplexer 310.

Meanwhile, in the case of image data, which image to be drawn is instructed by the presentation controller 306 (refer to FIG. 7). In addition, when image data for subtitles are used for drawing, the image data is deleted from the image memory 308 at the same time of use, but when image data for menus are used for drawing, the image data is retained in the image memory 308 without being deleted.

This is because menus are used for drawing depending on user operations, and thus the same image may be used for drawing several times.

The bottom part of FIG. 11 shows the interleaved storage of a VOB file and PNG files on the BD disc.

In general, on a ROM such as a CD-ROM and a DVD-ROM, AV data which is a series of reproduction units to be sequentially reproduced, are stored contiguously. As long as the data are stored contiguously, the drive reads out the data sequentially and gives the read data to the reading players.

However, a seek operation is performed between reproduction of individual consecutive segments in the case where AV data to be reproduced sequentially is separated and discretely placed on the disc, and thus, data reading is stopped during the seek operation. In other words, data supply may stop.

In the case of a BD-ROM, it is desirable that VOB files are recorded in consecutive areas of the BD-ROM. This is because some data such as subtitle data must be reproduced in synchronization with video data recorded in a VOB, and in this case, such subtitle data must be read out from the BD-ROM using some method as well as reading of the VOB file.

The methods of reading out subtitle data include a method of collectively reading out the entire subtitle image data (PNG files) before starting the reproduction of a VOB. However, the method is impractical because a large amount of memory for temporary recording is necessary.

In view of this, the present embodiment employs a method in which a VOB file is divided into several blocks, and the blocks are stored by being interleaved with image data.

The bottom part of FIG. 11 illustrates such interleaved storage. By appropriately placing divided VOB file data and image data in an interleaved manner, it becomes possible to store image data into the image memory 308 at a required timing without a temporary memory having a large capacity as described above.

Note that the reading of VOB data is suspended during the reading of image data, as a matter of course.

FIG. 12 is a diagram illustrating a model for continuous supply of VOB data using a track buffer 309 which solves the problem in the interleaved storage.

As has been described above, VOB data is temporarily accumulated into the track buffer 309. In the case where the rate at which data is inputted to the track buffer 309 is made higher than the rate at which the data is outputted from the track buffer 309, the amount of data accumulated in the track buffer 309 keeps increasing, as long as the data is being read out from the BD-ROM.

Here, the rate of input into the track buffer 309 is Va, and the rate of output from the track buffer 309 is Vb. Assume, as shown in the upper part of FIG. 12, that a contiguous VOB storage area starts with the logical address “a1” and ends with the logical address “a2”. Assume that image data is stored in an area between the logical addresses “a2” and “a3”, and no VOB data is read out from such area.

The lower part of FIG. 12 illustrates the amount of data accumulated in the track buffer 309. The lateral axis indicates time, and the vertical axis indicates the amount of data accumulated in the track buffer 309. Time “t1” indicates the start time of reading the data stored in a location specified by “a1” which is the start point of the contiguous VOB storage area.

After the time point, data is to be accumulated into the track buffer 309 at the rate of Va−Vb. This rate is a difference between an input rate and an output rate of a track buffer 309. Time “t2” indicates the reading time of data stored in a position specified by “a2” which is the end point of the contiguous storage area.

In other words, in the track buffer 309, the amount of data increases during the time duration between time “t1” and time “t2” at a rate Va−Vb, and B(t2) which is the amount of accumulated data at time “t2” can be obtained using the following Expression 1.

B(t2)=(Va−Vb)×(t2−t1) (Expression 1).

In the address up to an address “a3” on a BD-ROM, image data is stored consecutively. Since there is no input of data into the track buffer 309, the amount of data accumulated in the track buffer 309 decreases at an output rate of “−Vb”. Such decrease in the amount of data continues to a reading position “a3” corresponding to time “t3”. What is important here is that there is a possibility that the reproduction of the VOB stops if the amount of data accumulated in the track buffer 309 becomes 0 before the time “t3”, since it means that there is no VOB data to be supplied to the decoders.

In other words, the reproduction of VOBs continues without stopping when there remains data in the track buffer 309 at the time “t3”.

The condition under which the reproduction of VOBs continues without stopping can be shown using the following Expression 2.

B(t2)≧−Vb×(t3−t2) (Expression 2)

In other words, the position of each image data should be determined so that Equation 2 is satisfied.

(Structure of Navigation Data)

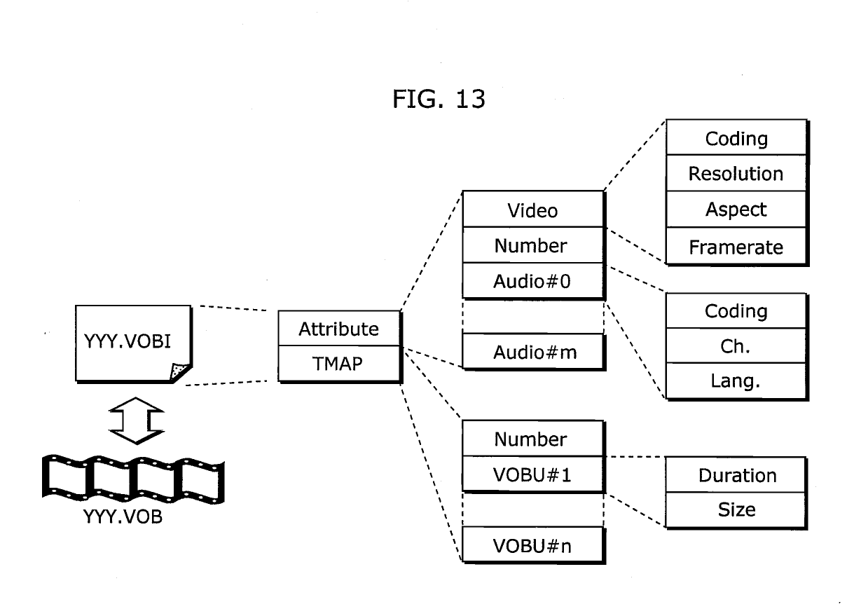

A description is given of the structure of the navigation data (BD management information) on the BD-ROM with reference to FIG. 13 to FIG. 19.

FIG. 13 is a diagram showing an internal structure of a VOB management information file (“YYY. VOBI”).

The VOB management information includes stream attribute information (Attribute) of the VOB, and a time map (TMAP). The stream attribute information includes a video attribute (Video) and audio attributes (Audio#0 to Audio#m). Especially in the case of audio streams, a single VOB can include plural audio streams at the same time, and thus the number of audio streams (Number) indicates the number of data fields for audio attributes.

The following lists fields included in the video attribute (Video) and possible values included in the respective fields.

Compression Mode (Coding):
MPEG-1
MPEG-2
MPEG-4

Resolution (Resolution):
1920×1080
1280×720
720×480
720×565

Aspect Ratio (Aspect):
4:3
16:9

Frame Rate (Framerate):
60
59. 94
50
30
29. 97
25
24

The following lists fields included in the audio attribute (Audio) and possible values included in the respective fields.

Compression Mode (Coding):
AC3
MPEG-1
MPEG-2
LPCM

The Number of Channels (Ch.):
1 to 8

Linguistic Attribute (Language):
JPN, EING, . . . .

The time map (TMAP), which is a table holding information for each VOBU, includes the number of VOBUs (Number) in the VOB, and VOBU information of each of such VOBUs (VOBU#1 to VOBU#n).

Each VOBU information includes the reproduction duration (Duration) of the VOBU, and the data size (Size) of the VOBU.

FIG. 14 is a diagram illustrating the details of each VOBU information.

As known widely, an MPEG stream is represented as two physical quantities of time and data size. For example, in Audio Code number 3 (AC3) which is an audio compression standard, compression is performed at a fixed bit rate, and thus the relationship between time and an address can be obtained using a linear equation.

The display duration of each frame in MPEG video data is fixed. For example, the display duration of one frame in MPEG video data for NTSC is 1/29. 97 seconds, but the data sizes of frames after compression greatly differ from frame to frame depending on the pictorial features, the picture types, that is, I, P, B pictures, and the like of the respective frames.

Accordingly, in the case of MPEG video data, it is impossible to represent a relationship between duration and each address by a general expression.

As a matter of course, it is impossible to represent a relationship between duration and each data size by a general expression in the case of an MPEG stream, that is, a VOB, in which MPEG video data is multiplexed.

Instead of this, a time map (TMAP) relates each address to time in a VOB. As shown in FIG. 14, a time map (TMAP) holds, as its entry, the number of frames in a VOBU and the number of packs in the VOBU on a per VOBU basis.

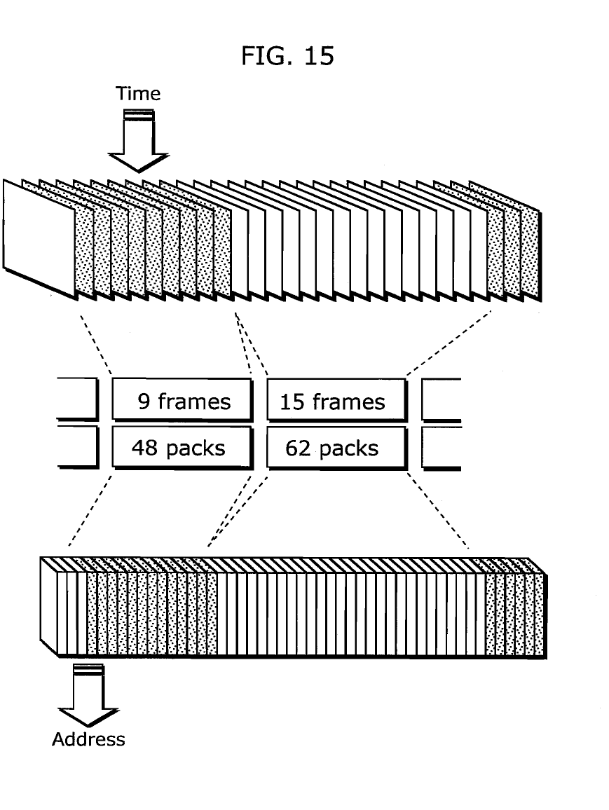

A description is given of a time map (TMAP) with reference to FIG. 15.

FIG. 15 is a diagram illustrating a method for obtaining address information using a time map.

As shown in FIG. 15, when time information (Time) is provided, first, the one of the VOBUs to which the time belongs is searched for. More specifically, the number of frames for each VOBU in a time map is added to determine the VOBU corresponding to the time which is the VOBU having a total number of frames which exceeds or matches the value obtained by calculating the time corresponding to the number of frames.

Next, the size of each VOBU immediately before the above-determined VOBU in the time map is added to obtain the value indicating the start address (Address) of a pack to be read out in order to reproduce the frame including the time point corresponding to the value.

In this way, in an MPEG stream, the address corresponding to given time information can be obtained.

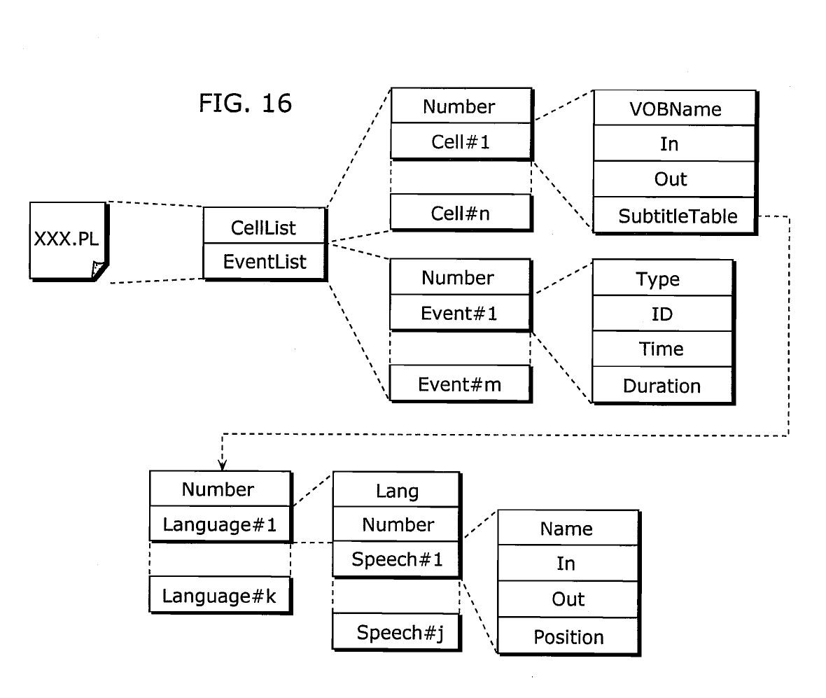

Next, a description is given of the internal structure of playlist information (“XXX.PL”) with reference to FIG. 16.

FIG. 16 is a diagram showing the structure of a playlist. The playlist is structured with a cell list (CellList) and an event list (EventList).

The cell list (CellList) is information indicating a sequence of cells to be reproduced in the playlist, and the cells are reproduced in the order of description in the cell list.

The cell list (CellList) is structured with the number of cells (Number) and cell information of each of such cells (Cell#1 to Cell#n).

Each cell information (Cell#1 to Cell#n) includes a VOB filename (VOBName), valid segment start time (In) and valid segment end time (Out) in the VOB, and a subtitle table (SubtitleTable).

The valid segment start time (In) and the valid segment end time (Out) are each represented by a frame number in the VOB, and it is possible to obtain the address of VOB data necessary for reproduction, using the above-described time map (TMAP).

The subtitle table (SubtitleTable) is a table holding information about subtitles to be reproduced in synchronization with the VOB. Since the VOB can have subtitles in plural languages as in the case of audio, the subtitle table (SubtitleTable) includes the number of languages (Number), which is followed by tables for the respective languages (Language#1 to Language#k).

Each language table (Language#1 to Language#k) includes language information (Language), the number of pieces of subtitle information about subtitles to be displayed (Number), and subtitle information about subtitles to be displayed (Speech#1 to Speech#j). Each subtitle information (Speech#1 to Speech#j) includes corresponding image data file name (Name), subtitle display start time (In) and subtitle display end time (Out), and the display position of the subtitles (Position).

The event list (EventList) is a table that defines events that occur in the playlist. The event list includes the individual events (Event#1 to Event#m) following the number of events. Each of the event (Event#1 to Event#m) includes an event type (Type), an event ID (ID), an event generation time (Time), and a valid duration (Duration).

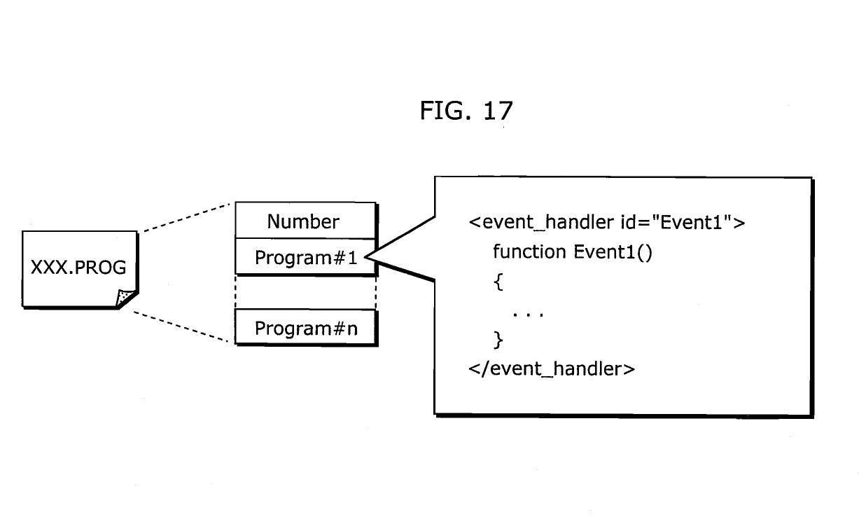

FIG. 17 is a diagram showing an event handler table (“XXX.PROG”) that holds event handlers (for time event and user event for menu selection) of each playlist.

The event handler table holds the number of event handlers which is programs defined (Number), and individual event handlers which is programs (Program#1 to Program#n).

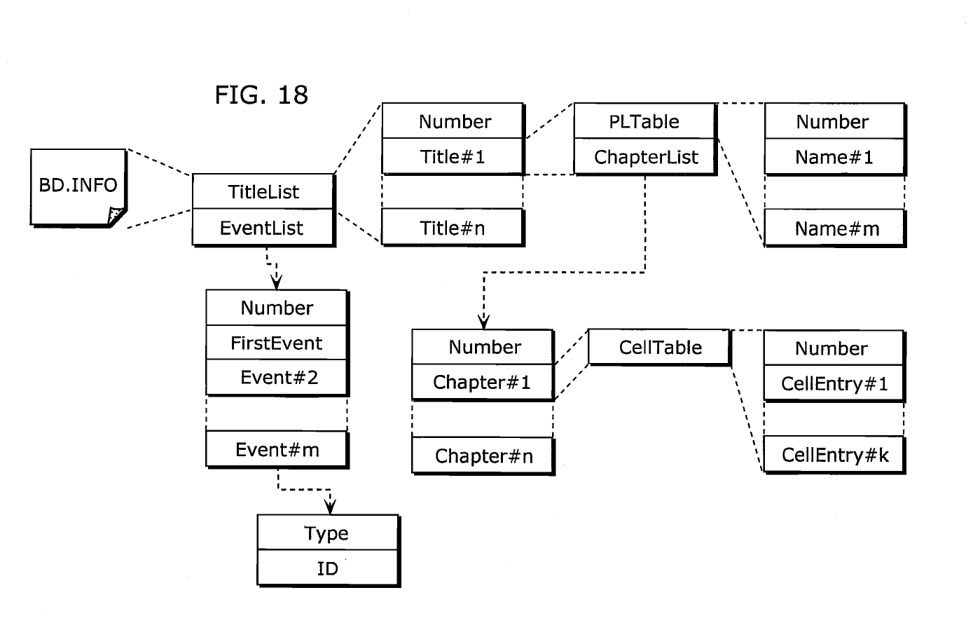

The description of each event handler which is program (Program#1 to Program#n) includes the definition about the start of the event handler (<event_handler> tag) and the event handler ID (event_handler_id) paired with the event ID. Between this and “{“and”}” following “function”, the program is described. Next, a description is given of the internal structure of information related to the entire BD disc (“BD.INFO”) with reference to FIG. 18.

FIG. 18 is a diagram showing the structure of BD.INFO which is the entire BD-ROM information.

The information related to the entire BD disc is structured with a title list (TitleList) and an event table (EventList) for global events.

The title list (Titlel-ist) includes the number of titles in the disc (Number), which is followed by title information of each of such titles (Title#1 to Title#n).

Each of the title information (Title#1 to Title#n) includes a playlist table (PLTable) holding playlists in the title and a chapter list (Chapterlist) holding chapters in the title. The playlist table (PLTable) includes the number of playlists in the title (Number) and the playlist names (Name), that is, the filenames of the respective playlists.

The chapter list (ChapterList) includes the number of chapters (Number) included in the titles and each of chapter information (Chapter#1 to Chapter#n). Each chapter information (Chapter#1 to Chapter#n) includes a cell table holding cells included in the chapter (CellTable). The cell table (CellTable) includes the number of cells (Number) and entry information of each cell (CellEntry#1 to CellEntry#k).

Each of the cell entry information (CellEntry#1 to CellEntry#k) is described using the name of the playlist including the cell, and the cell number in the playlist.

The event list (EventList) includes the number of global events (Number), and information about each of such global events (Event#1 to Event#m). What should be noted here is that the first defined global event is referred to as a first event (FirstEvent), and such event is first executed when a BD-ROM is inserted into a player. Information (one or more Event# Event#m) of each global event includes only the event type (Type) and event ID (ID).

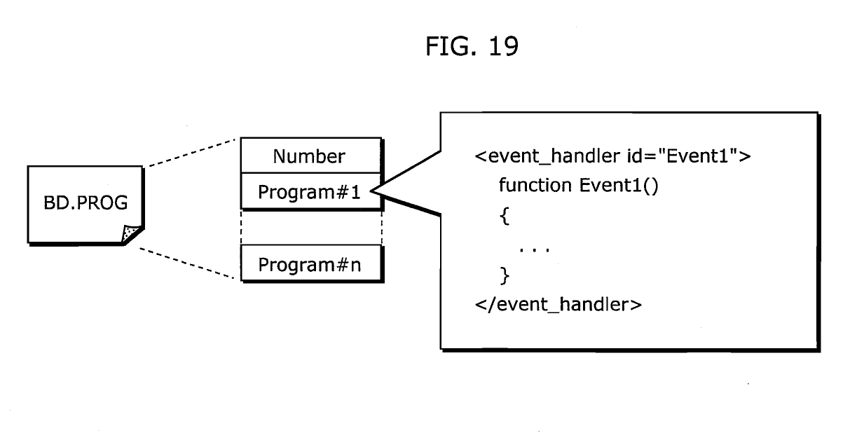

FIG. 19 is a diagram showing the structure of a global event handler table (“BD.PROG”).This table has the same content as the event handler table illustrated in FIG. 17, and the description is omitted.

(Mechanism of Event Occurrence)

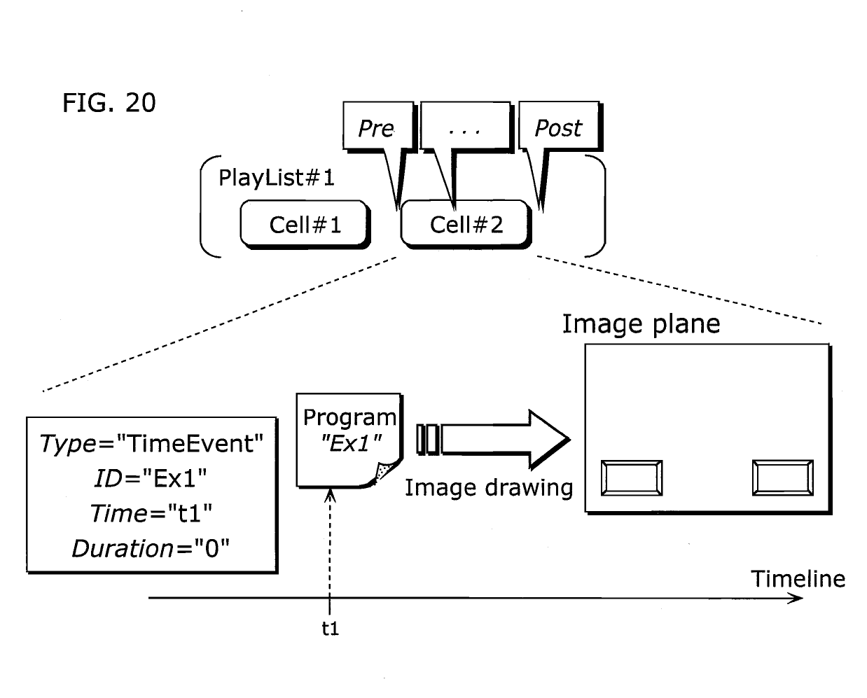

A description is given of a mechanism of event occurrence with reference to FIG. 20 to FIG. 22.

FIG. 20 is a diagram showing an example of a time event.

As described above, a time event is defined in the event list (EventList) in playlist information (“XXX.PL”).

In the case where an event is defined as a time event; that is, an event whose event type (Type) is “TimeEvent”, a time event with the identifier “Ex1” is outputted to the program processor 302 from the scenario processor 305 at the event generation time (“t1”).

The program processor 302 searches for an event handler with the event identifier “EX1”, and executes such target event handler. For example, an event such as the drawing or the like of two button images can be executed in the present embodiment.

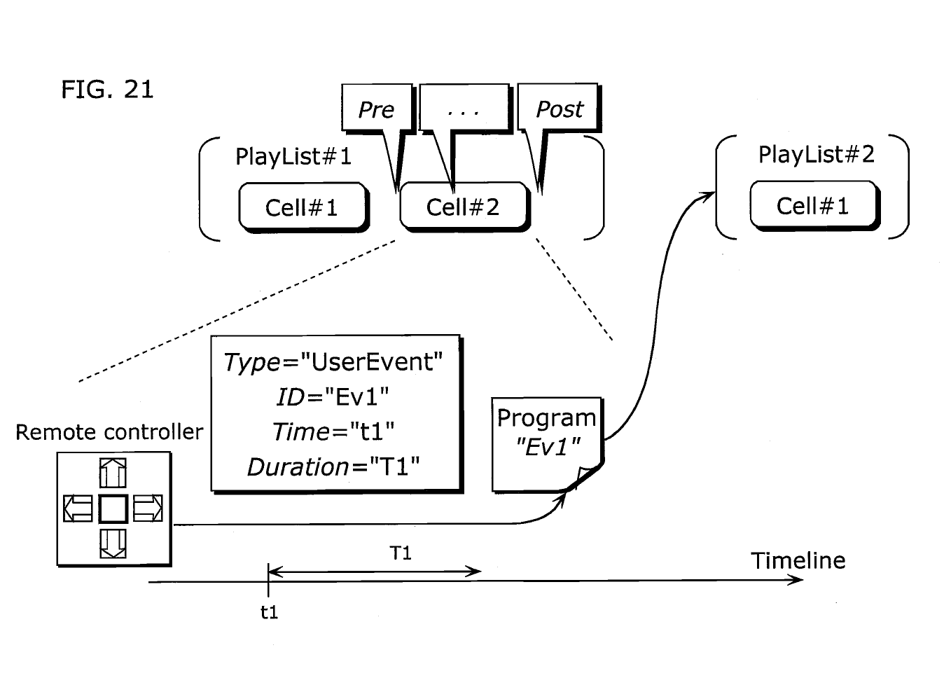

FIG. 21 is a diagram showing an example of a user event triggered by menu operation performed by a user.

As described above, a user event for menu operation is also defined in the event list (EventList) in playlist information (“XXX. PL”).

In the case where an event is defined as a user event; that is, an event whose event type (Type) is “UserEvent”, such user event becomes ready at the event generation time (“t1”). At this time, the event itself has not been generated yet.

This event is in the ready state during the time duration (T1) indicated by its validity specification information (Duration).

As shown in FIG. 21, when the user presses the Up, Down, Right, or/and Left keys or/and the “Determination” key on the remote controller, the UO manager 303 first generates a UO event, and outputs it to the program processor 302.

The program processor 302 sends the UO event to the scenario processor 305, and the scenario processor 305 searches for a user event valid at the time of receiving the UO event.

When the target user event is searched out, the scenario processor 305 generates the user event and outputs it to the program processor 302.

In the case of an example shown in FIG. 21, the program processor 302 searches for an event ID such as the event handler with the event identifier “Ev1”, and executes such target event handler. In this case, the reproduction of the playlist#2 is started.

The generated user event does not include information for identifying which one of the remote control keys has been pressed by the user. Information about the selected remote control key is notified to the program processor 302 by the UO event, and stored into the register of the virtual player.

The program of the event handler is capable of checking out the value of the register and executing branch processing.

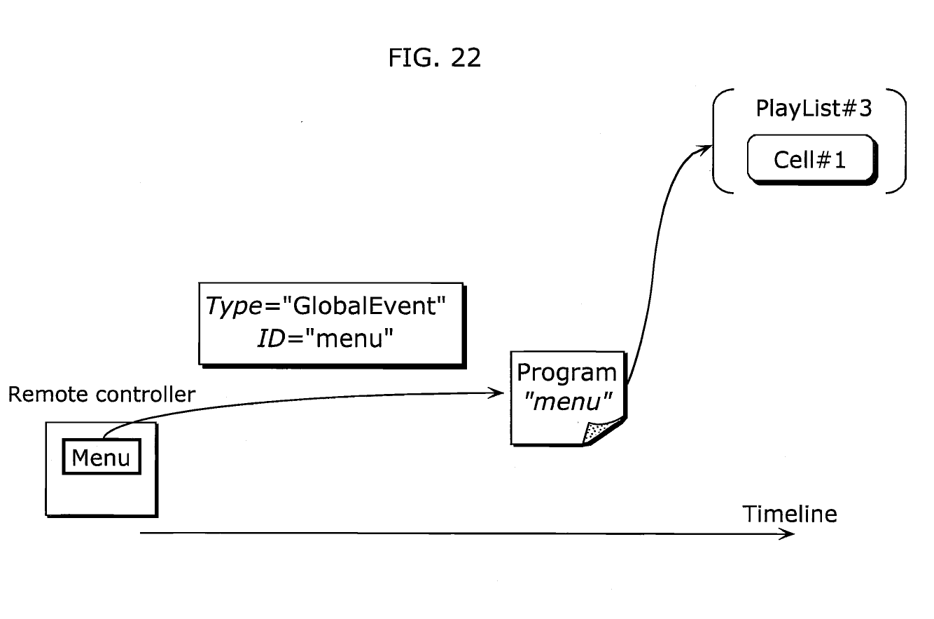

FIG. 22 is a diagram showing an example of a global event.

As described above, a global event is defined in the event list (EventList) in information about the entire BD-ROM disc (“BD. INFO”).

In the case where an event is defined as a global event; that is, an event whose event type (Type) is “GlobalEvent”, such event is generated only when the user has performed a remote control key operation.

When the user presses the “Menu” key, the UO manager 303 first generates a UO event, and outputs it to the program processor 302. The program processor 302 outputs such UO event to the scenario processor 305.

The scenario processor 305 generates corresponding global event and sends it to the program processor 302. The program processor 302 searches out an event handler with the event identifier “menu”, and executes such target event handler. For example, in the case shown in FIG. 22, the reproduction of the playlist#3 is started.

The menu keys referred to in this embodiment may be menu keys as those on a remote controller of a player which reproduces DVDs. Appropriate processing associated with each menu key can be executed on condition that the ID of each menu key is defined.

(Virtual Player Machine)

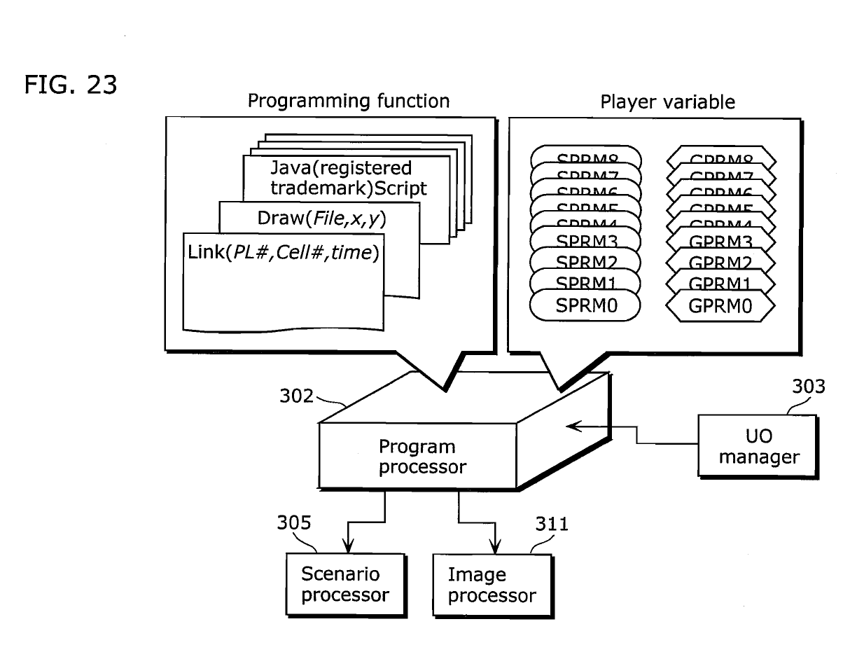

FIG. 23 is a diagram illustrating the functional structure of a program processor 302.

A description is given of the functional structure of the program processor 302 with reference to FIG. 23.

The program processor 302 is a processing module having a virtual player machine inside. The virtual player machine is a function model defined as a BD-ROM and does not depend on the type of BD-ROM player. In other words, the virtual player machine is guaranteed to execute the same function regardless of the type of the BD-ROM player.

The virtual player machine has two main functions. These functions are programming functions and player variables (registers). The player variables are stored and held in a register.

In the programming functions, three properties described below are defined as BD-ROM eigen functions based on lava (registered trademark) Script.

Link function: Link function is for stopping the current reproduction, and starting the reproduction starting with a specified playlist or cell, or at a specified time.

Link (PL#, Cell#, time)
PL#: Playlist name
Cell#: Cell number
time: Reproduction start time in the cell

PNG drawing function: for drawing specified PNG data onto the image plane 209

Draw (File, X, Y)
File: PNG filename
X: Position on the X coordinate
Y: Position on the Y coordinate

Image plane clear function: for clearing a specified area on the image plane 209.

Clear (X, Y, W, H)
X: Position on the X coordinate
Y: Position on the Y coordinate
W: Width in the X direction
H: Width in the Y direction
   Player variables include system parameters (SPRMs) indicating a setting value and the like of the player, and general parameters (GPRMs) that can be used for general purposes.

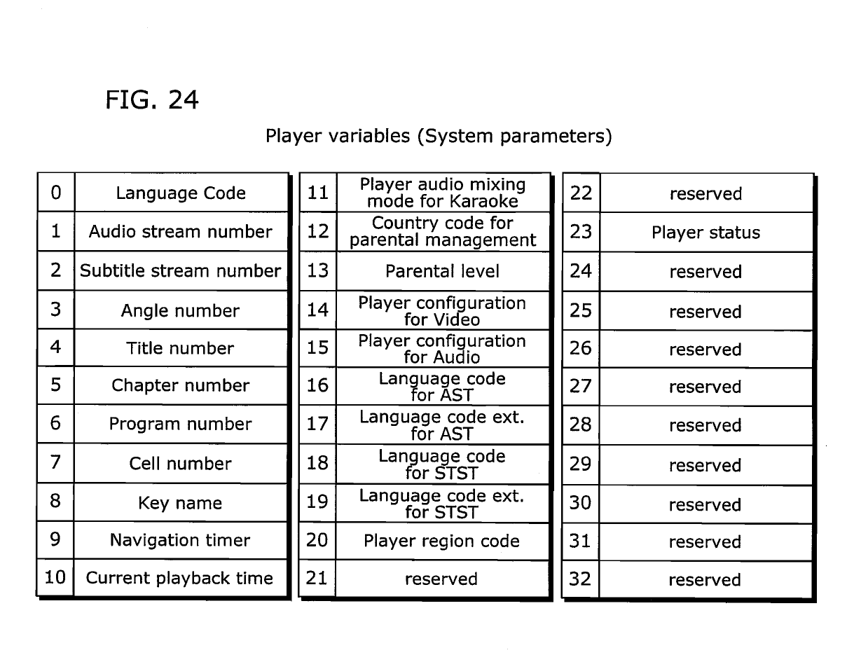

FIG. 24 is a diagram showing a list of system parameters (SPRMs).

SPRM (0): Language code

SPRM (1): Audio stream number

SPRM (2): Subtitle stream number

SPRM (3): Angle number

SPRM (4): Title number

SPRM (5): Chapter number

SPRM (6): Program number

SPRM (7): Cell number

SPRM (8): Key name

SPRM (9): Navigation timer

SPRM (10): Current playback timer

SPRM (11): Player audio mixing mode for Karaoke

SPRM (12): Country code for parental control

SPRM (13): Parental level

SPRM (14): Player configuration for Video

SPRM (15): Player configuration for Audio

SPRM (16): Language code for AST

SPRM (17): Language code ext. for AST

SPRM (18): Language code for STST

SPRM (19): Language code ext. for STST

SPRM (20): Player region code

SPRM (21): reserved

SPRM (22): reserved

SPRM (23): Player status

SPRM (24): reserved

SPRM (25): reserved

SPRM (26): reserved

SPRM (27): reserved

SPRM (28): reserved

SPRM (29): reserved

SPRM (30): reserved

SPRM (31): reserved

Note that the programming functions of the virtual player are defined in the present embodiment based on lava (registered trademark) Script, but these programming functions may be defined based on B-Shell and Perl Script used in UNIX (registered trademark) OSs. In other words, the program language used in the present invention is not limited to Java (registered trademark) Script.

(Example of Program)

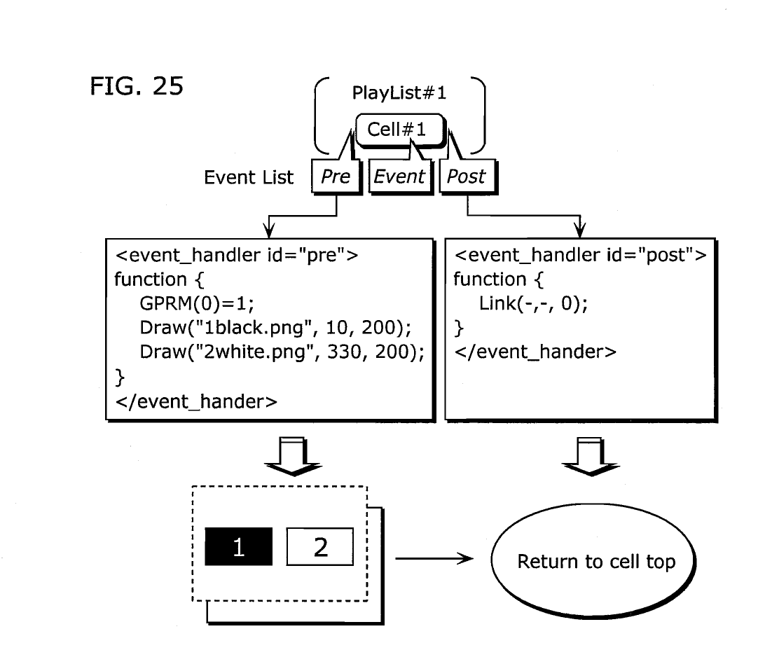

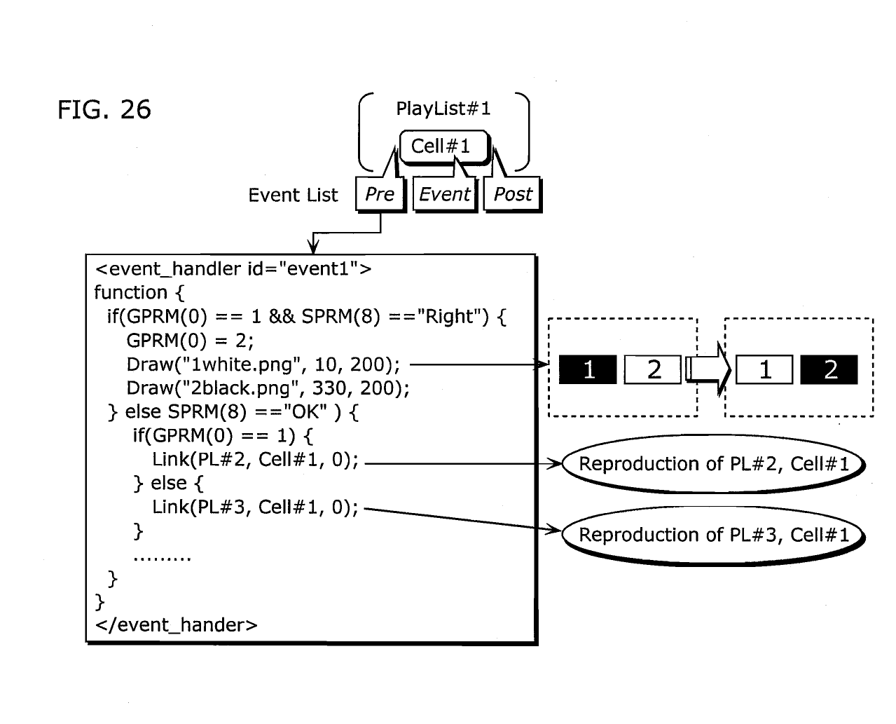

FIG. 25 and FIG. 26 are diagrams showing examples of programs as event handlers.

FIG. 25 is a diagram showing an example of a program in an event handler concerning control of a menu screen having two selection buttons.

The program illustrated on the left of FIG. 25 is executed based on the top time event of the cell (PlayList#1. Cell#1). Here, “1” is first set to one of the general parameters GPRM (0). GPRM(0) is used in the program to identify the selected button. The initial value held in the original status shows the status where a button [1] positioned at the left side is selected.

Next, using a drawing function “Draw”, the PNG image of each of the button [1] and button [2] is drawn. The button [1] is formed by drawing the PNG image “1black. png” in an area that extends from the coordinates (10, 200) as the starting point (upper left corner).

The button [2] is formed by drawing the PNG image “2white. png” in an area that extends from the coordinates (330, 200) as the starting point (upper left corner).

Then, the program illustrated on the right of FIG. 25 is executed based on the last time event of the current cell. Here, it is specified, using a Link function, that the cell should be reproduced from the top again.

FIG. 26 is a diagram showing an example of a program in an event handler concerning a user event for menu selection.

Programs corresponding to the respective keys, in the case where the “Left” key, “Right” key, and “Determination” key are pressed, are described in the event handler. As described with reference to FIG. 21, when the user presses a remote control key, a user event is generated, and then the event handler shown in FIG. 26 is activated.

In this event handler, branch processing is performed using the value of GPRM (0) for identifying the selected button and using SPRM (8) for identifying the selected remote control key.

Condition 1) when button [1] is currently selected and “Right” key is selected,

GPRM(0) is reset to “2” so as to change the currently selected button to the button [2] on the right.

The images of the respective button [1] and button [2] are re-drawn.

Condition 2) when the “Determination (OK)” key is selected, and the button [1] is selected,

the reproduction of the playlist#2 is started.

Condition 3) when the “Determination (OK)” key is selected, and the button [2] is selected,

the reproduction of playlist#3 is started.

The program shown in FIG. 26 is interpreted as above, and it is executed.

(Flow of Player Processes)

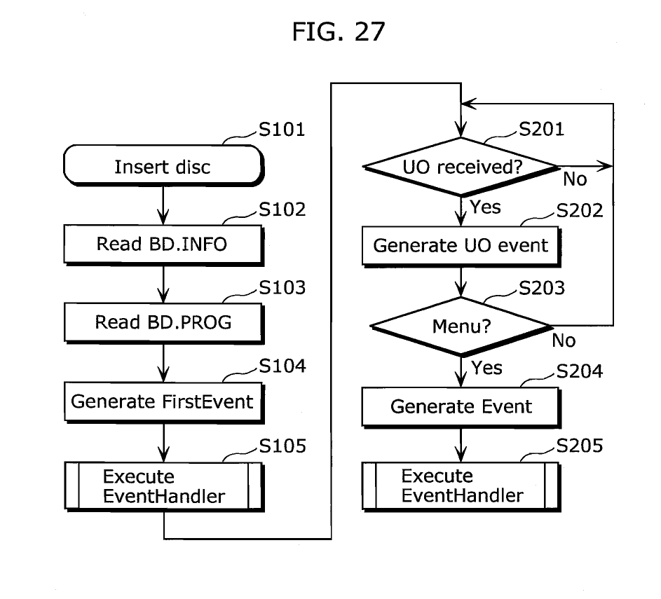

Next, a description is given of the flow of processes performed by the player with reference to FIG. 27 to FIG. 30.

FIG. 27 is a flowchart showing a flow of basic processing for reproducing AV data in a BD-ROM player.

When the BD-ROM is inserted (S101), the BD-ROM player reads and analyzes the “BD.INFO” file (S102), and then reads the “BD.PROG” file (S103).The “BD.INFO” file and “BD.PROG” file are both stored into the management information storage memory 204 once, and analyzed by the scenario processor 305.

Next, the scenario processor 305 generates the first event based on the first event (FirstEvent) information in the “BD.INFO” file (S104). The program processor 302 receives the generated first event, and executes an event handler corresponding to such event (S105).

It is expected that the playlist information that should be reproduced first is stored in the event handler corresponding to the first event. If there is no instruction to reproduce a playlist, the player keeps waiting for a user event without reproducing anything (No in S201).

When a UO manager 303 accepts remote controller operation from a user (Yes in S201), a UO event for the program processor 302 is generated (S202).

The program processor 302 judges whether or not such UO event is a menu key event (S203). In the case of a menu key event (Yes in S203), the program processor 302 outputs the UO event to the scenario processor 305, and the scenario processor 305 generates a user event (S204). The program processor 302 executes an event handler corresponding to such generated user event (S205).

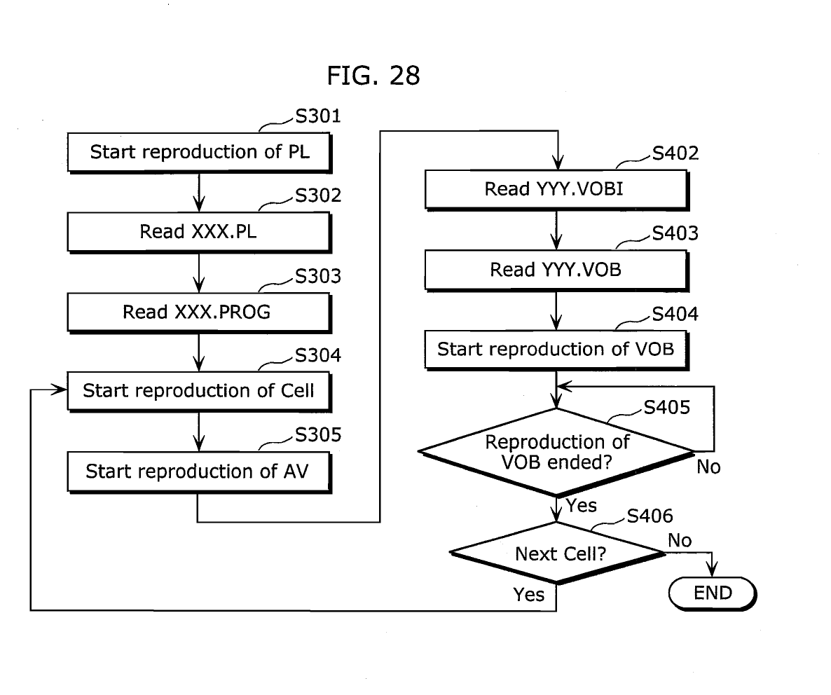

FIG. 28 is a flowchart showing a flow of processing from the start of reproducing a playlist in a BD-ROM player to the end of reproducing VOBs.

As described above, the reproduction of the playlist is started by a first event handler or a global event handler (S301). The scenario processor 305 reads and analyzes the playlist information “XXX.PL” as information required to reproduce the target playlist (S302), and reads the program information “XXX.PROG” corresponding to such playlist (S303).

Then, the scenario processor 305 starts the reproduction of a cell based on the cell information registered in the playlist (S304). Since the reproduction of the cell means that there is a request from the scenario processor to the presentation controller 306, the presentation controller 306 starts the reproduction of the AV data (S305).

When the reproduction of the AV data starts, the presentation controller 306 reads and analyzes the information file (XXX.VOBI) of the VOB corresponding to the cell to be reproduced (S402).With reference to the time map, the presentation controller 306 identifies the VOBU to be reproduced and the address of such VOBU, and notifies such address to the drive controller 317 The drive controller 317 reads out the target VOB data “YYY.VOB” (S403). Accordingly, the read VOB data is sent to the decoders, and the reproduction of such data starts (S404). The reproduction of the VOB continues until the end of the reproduction segments of such VOB is reached (S405). In the case where a next cell exists when the reproduction ends (Yes, in S406), the reproduction of the next cell starts (S304). In addition, processing concerning reproduction ends when there is no next cell (No in S406).

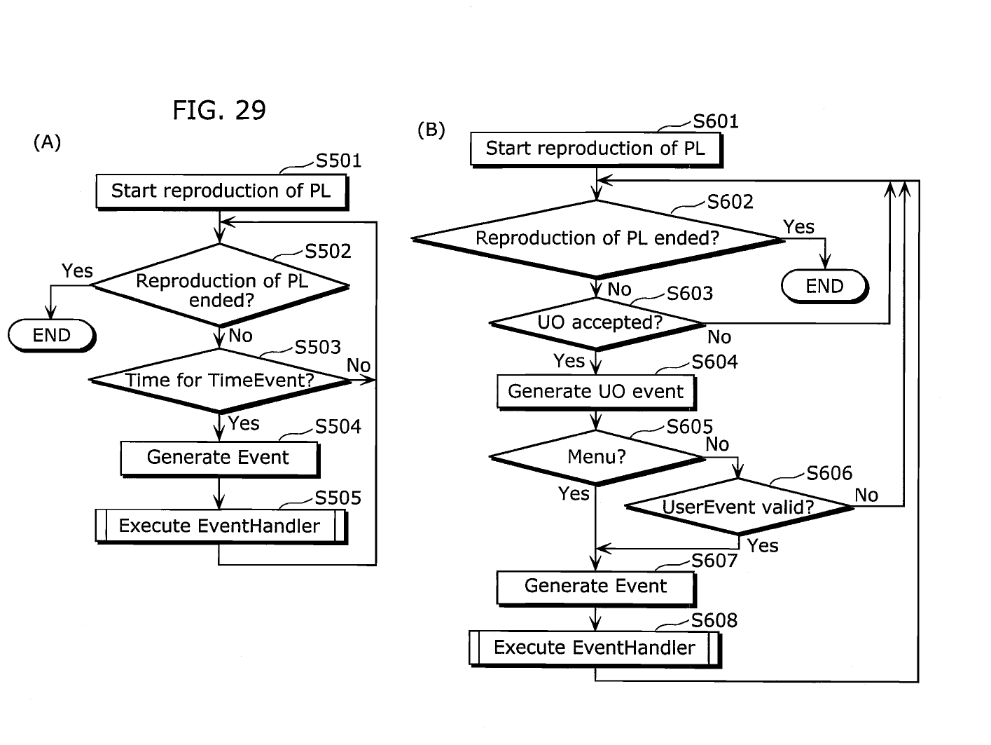

FIGS. 29(A) and 29(B) each is a flowchart showing the flow of event processing after the start of the reproduction of AV data. FIG. 29(A) is a flowchart showing the flow of processing concerning a time event in a BD-ROM player.

The BD-ROM player is an event-driven player. When the reproduction of a playlist starts, event processes for time events, user events, and subtitle display are respectively activated, and executed in parallel.

After the reproduction of the playlist starts in the BD-ROM player (S501), that the reproduction of the playlist has not yet ended is checked out (No in S502), the scenario processor 305 checks whether or not it is the time for event occurrence.

When it is the time of event occurrence (Yes in S503), the scenario processor 305 generates a time event (S504). The program processor 302 receives the time event, and executes the corresponding event handler (S505).

In addition, when it is before the time of event occurrence (No in S503), and when the execution of the event handler ends, the processing after the check of the reproduction of the playlist (S502) is repeated.

Meanwhile, in the case where the check in Step S502 shows that the reproduction of the playlist has ended, the time event processes are forcefully terminated.

FIG. 29(B) is a flowchart showing the flow of processing concerning a user event in a BD-ROM player.

After the reproduction of the playlist starts in the BD-ROM player 1 (S601), that the reproduction of the playlist has not yet ended is checked out (No in S602), the UO manager 303 checks whether or not a UO has been received.

When the UO has been received, the UO manager 303 generates a UO event (S604). The program processor 302 receives a UO event, and checks whether or not the UO event is a menu call.

In the case where the UO event is a menu call (Yes in S605), the program processor 302 causes the scenario processor 305 to generate an event (S607), and the program processor 302 executes the corresponding event handler (S608).

In the case where the check in Step S605 shows that the UO event is not a menu call (No in S605), it indicates that the UO event is an event that is generated by operating a cursor key or the “Determination” key. In this case, the scenario processor 305 determines whether the current time is within the valid duration of the user event. When the current time is within the valid duration (Yes in S606), the scenario processor 305 generates a user event (S607), and the program processor 302 executes the target event handler (S608).

In addition, when no UO has been received (No in S603), when the current time is not within the valid duration of the user event (No in S606), and when the execution of the event handler has ended, the processing after the check of the reproduction of the playlist (S602) is repeated.

Meanwhile, in the case where the check in Step S602 shows that the reproduction of the playlist has ended (Yes in S602), the user event processes are forcefully terminated.

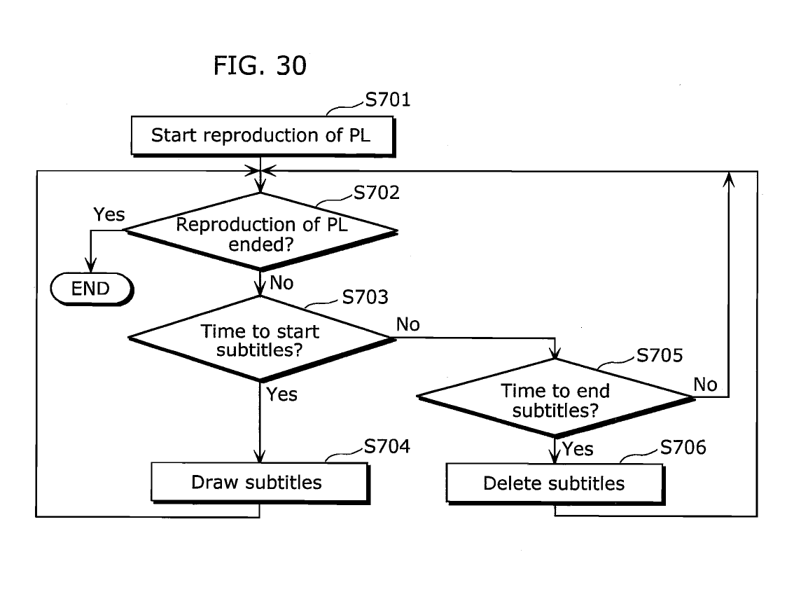

FIG. 30 is a flowchart showing the flow of processing subtitle data in a BD-ROM player.

After the reproduction of the playlist starts in the BD-ROM player (S501), that the reproduction of the playlist has not yet ended is checked out (No in S702), the scenario processor 305 checks whether or not it is the time for starting display of subtitles. If the scenario processor 305 checks that it is the time for starting display of subtitles (Yes in S703), the scenario processor 305 instructs the presentation controller 306 to draw the subtitles, and the presentation controller 306 instructs the image processor 311 to draw the subtitles. The image processor 311 draws subtitles in an image plane 209 according to the instruction (S704).

In addition, when the start time at which subtitles are drawn has not yet been reached (No in S703), whether the current time is the time to end drawing subtitles is checked. When it is judged that the current time is the time to end drawing subtitles (Yes in S705), the presentation controller 306 instructs the image processor 311 to delete the subtitles.

The image processor 311 deletes the drawn subtitles in the image plane 209 according to the instruction (S706). In addition, when the drawing of subtitles by the image processor 311 ends (S704), when the deletion of the subtitles by the image processor 311 ends (S706), and it is judged that the current time is not the time to end drawing subtitles (No in S705), the processing after the check of the reproduction of the playlist (S702) is repeated.

Meanwhile, in the case where the check in Step S702 shows that the reproduction of the playlist has ended, the subtitle processes are forcefully terminated.

By the above-described operations, the BD-ROM player executes basic processing of reproducing a BD-ROM based on an instruction from a user or BD management information or the like recorded on the BD-ROM.

### SECOND EMBODIMENT

Next, the second embodiment according to the present invention is described.

In the second embodiment, it is described that reproduction is controlled using a region code which is one of setting values stored in a BD-ROM player.

The basic structure and processing of a BD-ROM player according to the second embodiment are the same as the structure and processing according to the first embodiment. Therefore, only characteristic structure and processing of the second embodiment are described below.

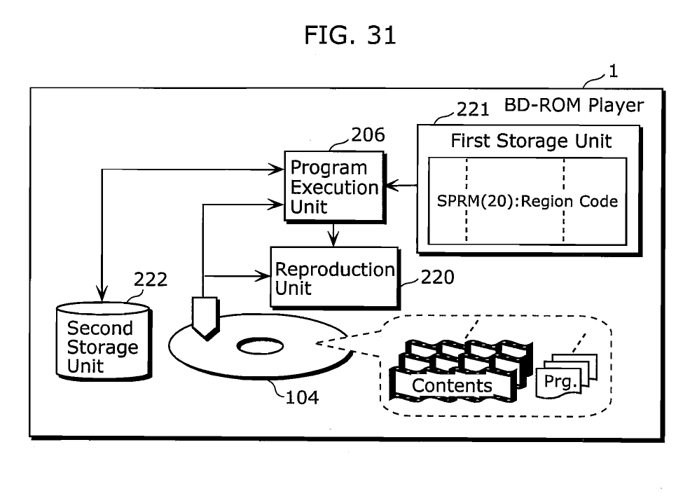

FIG. 31 is a functional block diagram showing a main functional structure of a BD-ROM player according to the second embodiment.

A BD-ROM player 1 according to the second embodiment is one example of the reproduction apparatus in accordance with the aspect of the present invention. As shown in FIG. 31, the BD-ROM player 1 includes a program execution unit 206, a reproduction unit 220, a first storage unit 221, and a second storage unit 222. The BD-ROM player 1 has a function of reproducing contents recorded on a BD-ROM 104.

Here, the BD-ROM 104 according to the second embodiment is one example of the information recording medium in accordance with the aspect of the present invention, and a BD reproduction program recorded on the BD-ROM 104 is one example of the program in accordance with the aspect of the present invention. It should be noted that FIG. 31 shows mainly a part of the BD-ROM player 1 for explaining the characteristic processing of the BD-ROM player 1 according to the second embodiment. In FIG. 31, the program storage memory 203 of FIG. 6 is not shown.

The reproduction unit 220 reproduces the BD-ROM. The reproduction unit 220 includes the management information storage memory 204, the management information processing unit 207, the AV storage memory 205, the presentation processing unit 208, the image plane 209, the video plane 210, and the overlay processing unit 211 of FIG. 6.

The program execution unit 206 executes the BD reproduction program read out from the BD-ROM 104 as described above. The program execution unit 206 is one example of the execution unit in the reproduction apparatus in accordance with the aspect of the present invention.

The first storage unit 221 is a storage device in which the system parameters (SPRM) shown in FIG. 24 are stored. This means that, a SPRM(20) indicating a region code is stored in the first storage unit 221.

Here, the first storage unit 221 is actually implemented as a register of the program processor 302 included in the program execution unit 206 (refer to FIG. 7), for example.

The second storage unit 222 is a nonvolatile storage device from/into which the program execution unit 206 can read and write information. For instance, the second storage unit 222 is actually implemented as a hard disc or a nonvolatile memory such as a flash memory.

Although the second storage unit 222 is not shown in FIG. 6, any BD-ROM player always has such second storage unit 222. When the BD reproduction program recorded on the BD-ROM 104 is processed, the program execution unit 206 can read and write information from/into the second storage unit 222.

Since the second storage unit 222 is nonvolatile, the information written by the program execution unit 206 is held in the second storage unit 222 even after a user turns power off the BD-ROM player 1.

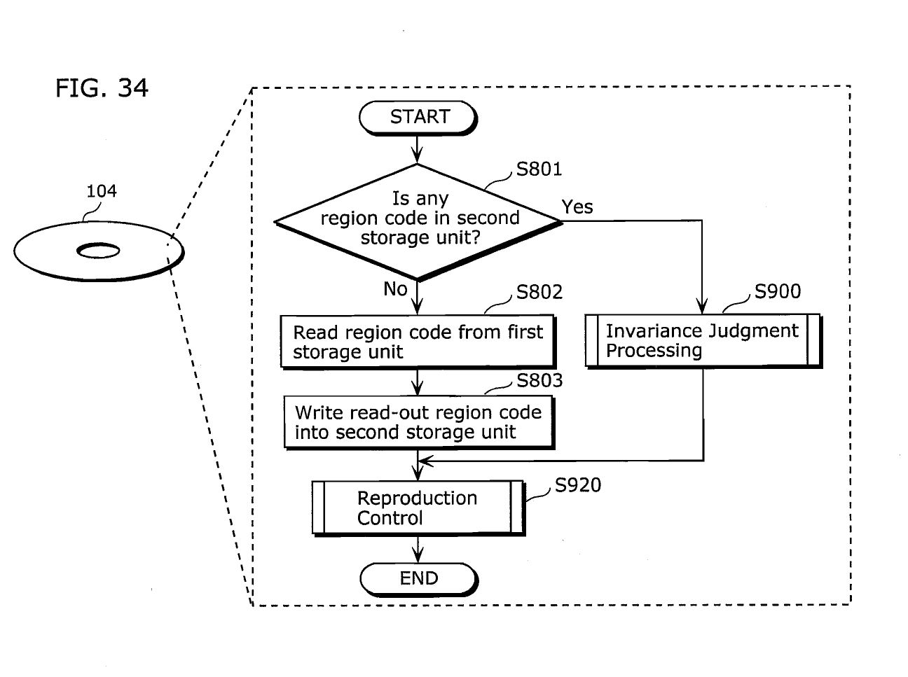

In the second embodiment, according to the reproduction program on the BD-ROM 104, the program execution unit 206 reads a region code from the first storage unit 221 and stores the region code into the second storage unit 222. The processing is described in more detail further below with reference to FIG. 34.

The region code is one example of the setting value in the information recording medium in accordance with the aspect of the present invention. The region code has a value which has never been changed in principal in a BD ROM player since the value had set in the BD-ROM player at factory default or initialization. Furthermore, the region code is information for identifying a region to which the BD-ROM player is to be distributed. In other words, the region code is information used to specify which region the BD-ROM player belongs to.

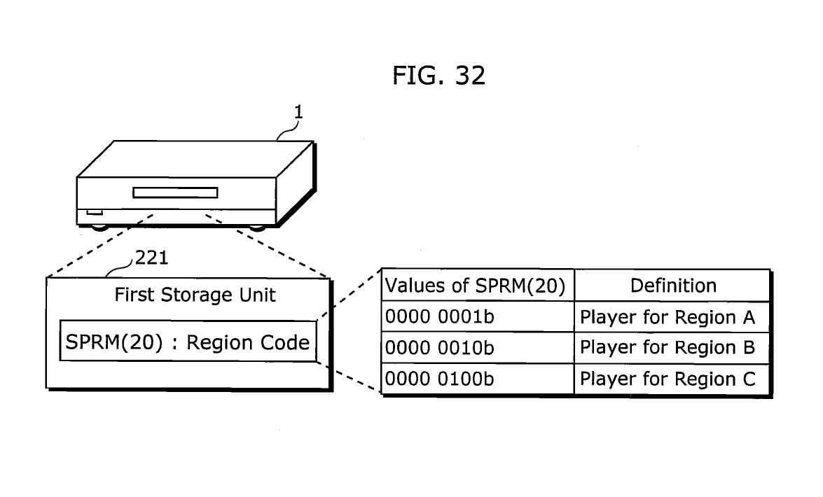

FIG. 32 is a diagram showing examples of such region codes.

A region code held in each BD-ROM player 1 is one of various values shown in FIG. 32. Each region code is assigned to a corresponding region. The region code should not have any other value except the value assigned to the corresponding region.

Also, in the same manner as previously described for the DVD player, it is possible to switch contents to be reproduced according to the region code of the BD-ROM player 1.

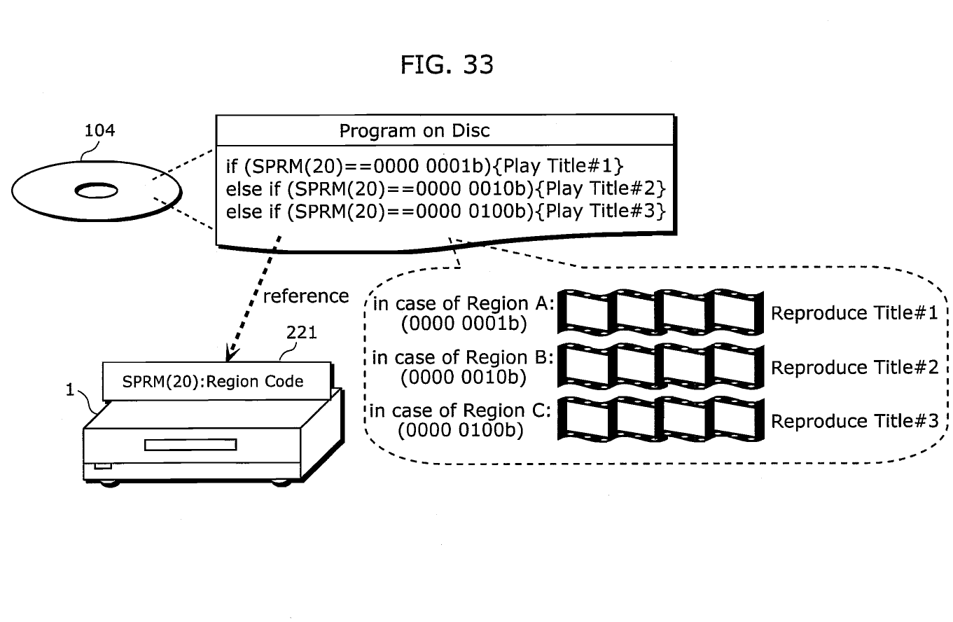

FIG. 33 is a schematic diagram showing a program for switching between contents to be reproduced, according to the region code of the BD-ROM player 1.

Previously, onto the BD-ROM 104, a program having description as shown in FIG. 33 is recorded as the BD reproduction program.

Thereby, when the BD-ROM 104 is inserted into the BD-ROM player 1, the program is read and executed by the program execution unit 206.

Practically, a value of SPRM(20) stored in the first storage unit 221, namely a region code, is referred to by the program execution unit 206. Then, the reproduction unit 220 is controlled to reproduce a content in association with the region code.

For example, if the BD-ROM player 1 is for a region A, the region code of the BD-ROM player 1 is “0000 0001b”. Therefore, when the program is executed, a content “Title#1” is reproduced. Likewise, if the BD-ROM player 1 is for a region B, the region code of the BD-ROM player 1 is “0000 0010b”. Then, a content “Title#2” in association with the region code is reproduced. Further, if the BD-ROM player 1 is for a region C, the region code of the BD-ROM player 1 is “0000 0100b”. Then, a content “Title#3” in association with the region code is reproduced.

As described above, as shown in FIG. 33, by recording the BD reproduction program which uses a region code onto the BD-ROM, it is possible to switch contents to be reproduced according to a region which the BD-ROM player belongs to.

Moreover, it is also possible to simply restrict reproduction of contents recorded in the BD-ROM player 1, not switching contents to be reproduced among plurality of contents as described above.

For example, it is assumed that a content provider wishes to delay timings of providing a certain content (content a) gradually for respective plural regions, as marketing strategy. Under the assumption, it is possible to manufacture a BD-ROM on which the content a is recorded and which is permitted to be reproduced in a region A.

Practically, the BD reproduction program is recorded on the BD-ROM, and the BD reproduction program refers to a region code. When the region code indicates the region A, then the BD reproduction program permits the BD-ROM player 1 to reproduce the content a. On the other hand, when the region code does not indicate the region A, then the BD reproduction program prohibits the BD-ROM player 1 from reproducing the content a.

It is also possible that description is given in the BD reproduction program, and the description enables the BD reproduction program to prohibit players having region codes which do not indicate the region A from reproducing the content a, and then to instruct the players to reproduce a content for notifying users of the players about the prohibition.

Here, an example of the content for notifying users of the players about the prohibition of reproduction of the content a is a video content for displaying characteres “This BD-ROM player is not allowed to reproduce the content a”, for example. The content may be an audio content for conveying the same message by sound.

As described above, by using the region code in the BD-ROM player 1, it is possible to control reproduction of contents according to a region which the BD-ROM player 1 belongs to.

According to the necessity of marketing strategy, content copyright protection, or the like, content providers can create programs which cause the BD-ROM players 1 to perform the above-described reproduction control.

Here, as described above, the BD-ROM player has only one value as the region code, and the value is not changed in principal. However, it is still possible to manufacture unauthorized BD-ROM players in which users of the BD-ROM players can change region codes as the users desire. There is no way content provider cannot stop such manufacturing.

Such a BD-ROM player in which a region code has been changed has a problem that the BD-ROM player can reprocude a content against an intension of a provider of the content. For example, the BD-ROM player can reprocude a content, which is not allowed by a provider of the content.

In order to address these problems, a BD reproduction program is recorded on the BD-ROM 104 in order to confirm whether or not a region code stored in the BD-ROM player is appropriate.

Thereby, regardless of whether or not a BD-ROM player is not authorized, reproduction of a content can be controlled depending on whether or not a region code of the BD-ROM player is appropriate.

The following describes [i] details of the BD reproduction program recorded on the BD-ROM 104, and [ii] processing performed by the BD-ROM player 1 based on the BD reproduction program, according to the second embodiment, with reference to FIGS. 34 to 38.

Firstly, the processing performed by the BD-ROM player 1 according to the second embodiment is described with reference to FIG. 34.

FIG. 34 is a flowchart of the processing performed by the BD-ROM player 1 based on the BD reproduction program according to the second embodiment.

The program execution unit 206 confirms whether or not any region code is stored in the second storage unit 222 (S801).

If no region code is stored in the second storage unit 222 (No at S801), then the program execution unit 206 reads out a value of SPRM(20) indicating a region code from the first storage unit 221 (S802), and writes the value as the region code into the second storage unit 222 (S803).

This means that, when the BD-ROM 104 is inserted into the BD-ROM player 1 at the first time, a region code stored in the first storage unit 221 is copied to the second storage unit 222. It should be noted that, when the region code is stored into the second storage unit 222, it is also possible to store a flag which indicates the storing of the region code into the second storage unit 222 together with the region code.

In this case, the program execution unit 206 checkes existence of the flag to confirm whether or not any region code is stored in the second storage unit 222.

After writing the region code into the second storage unit 222, the program execution unit 206 controls the reproduction unit 220 to reproduce a content in association with the region code, according to the BD reproduction program or another BD reproduction program (S920).

For example, if a content recorded on the BD-ROM 104 is associated with the region code, a menu screen for reproduction of the content is outputted. Or, reproduction of the content is automatically started.

On the other hand, if a certain region code is stored in the second storage unit 222 (Yes at S801), then invariance judgment processing for the region code stored in the first storage unit 221 is performed by comparing [i] the region code stored in the first storage unit 221 to [ii] the region code stored in the second storage unit 222 (S900).

Depending on a result of the comparison, the program execution unit 206 controls the BD-ROM player 1 to perform different processing for content reproduction (S920).

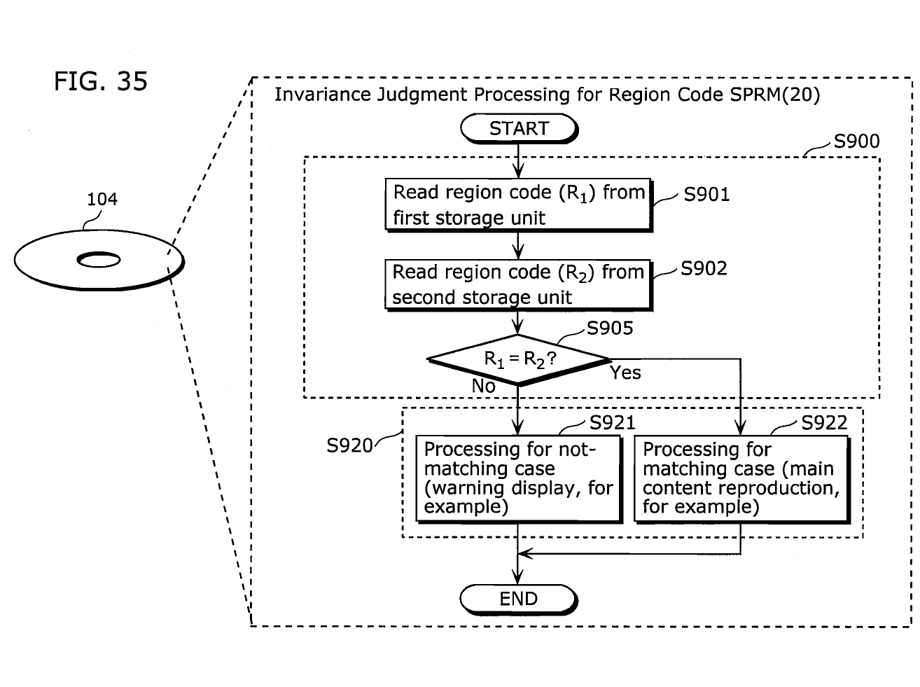

Next, flows of the invariance judgment processing (S900) and the reproduction control processing (S920) based on a result of the invariance judgment processing are described in detail with reference to FIG. 35.

FIG. 35 is a flowchart showing a flow of the constancy judgment processing and a flow of the reproduction control processing shown in FIG. 34 in more detail.

The program execution unit 206 reads out a region code from the first storage unit 221. More specifically, a value of SPRM(20) stored in the first storage unit 221 is read out (S901). Hereinafter, the value of SPRM(20) is referred to as “R₁”.

In addition, a region code is read out from the second storage unit 222, in other words, a region code which has previously been copied from the first storage unit 221 is read out from the second storage unit 222 (S902). Hereinafter, the region code is referred to as “R₂”.

Then, R₁ is compared with R₂ (S905). Here, it is assumed that, as a result of the comparison, R₁ is different from R₂ (No at S905). This assumption indicates that R₁ stored in the first storage unit 221, namely the value of the SPRM(20), has been changed since the BD-ROM 104 had firstly been inserted into the BD-ROM player 1.

That is, it is detected that the BD-ROM player 1 violates the principal in which a region code should be fixed in each player.

In this case, the program execution unit 206 performs processing which is to be performed when R₁ is different from R₂ (S921). More specifically, the processing unit 206 controls the reproduction unit 220 to prohibit reproduction of contents recorded on the BD-ROM 104.

In addition, the processing unit 206 controls the reproduction unit 220 to reproduce a content which notifies a user of the BD-ROM player of that the content is prohibited from being reproduced.

Here, the “content which notifies a user of the BD-ROM player of that the content is prohibited from being reproduced” is one example of the second content in the aspect of the present invention. An example of such a content is an image content displayed as characters “Since the region code has been changed, Title#1 is prohibited from being reproduced”, or an audio content for conveying the same message by sound.

Moreover, in addition to a main essential content such as a movie, a content or the like for merely notifying information is generally recorded on the BD-ROM 104. Therefore, in order to distinguish these contents from each other, the main content such as a movie is hereinafter referred to as a “main content”. The “main content” is one example of the first content in the information recording medium in accordance with the aspect of the present invention.

Referring back to FIG. 35, if the comparison indicates that R₁ is the same as R₂ (Yes at S905), then the program execution unit 206 performs processing which is to be performed when R₁ is the same as R₂ (S922).

More specifically, when the main content is associated with the region code, the program execution unit 206 controls the reproduction unit 220 to reproduce the main content, or output a menu screen for reproduction of the main content, for example.

Or, if there are plurality of main contents as described with reference to FIG. 33, the program execution unit 206 controls the reproduction unit 220 to select, from among the main contents, a main content in association with the region code, and to reproduce the selected main content or output a menu screen for reproduction of the main content.

The processing for the case where R₁ is different from R₂ and the processing for the case where R₁ is the same as R₂ depend on the BD reproduction program recorded on the BD-ROM 104 and have previously been decided by the content provider. In short, a content is reproduced based on intension of a provider of the content.

Here, it is assumed that the invariance judgment processing is performed in a situation where a user of the BD-ROM player 1 somehow initializes the second storage unit 222 after writing the region code into the second storage unit 222. In this assumption, the comparison of R₁ with R₂ (refer to FIG. 35) cannot be performed. Therefore, the processing of preventing such initialization of the second storage unit 222 may be executed by the BD-ROM player 1.

Here, on the BD-ROM 104 on which a main content such as a movie is recorded, a content which is not essential for the BD-ROM 104 (hereinafter, referred to as an “accessory content”), such as previews of other movies or advertisements of other products, is generally recorded.

Once a user watches an accessory content such as an advertisement video, the user usually thinks that the accessory content does not need to be watched any longer.

Therefore, if any region code is not stored in the second storage unit 222, in other words, if the BD-ROM 104 is inserted into the BD-ROM player at the first time, the program execution unit 206 controls to write the region code from the first storage unit 221 into the second storage unit 222, and to reproduce the accessory content prior to the main content.

This means that, while the region code is written and held in the second storage unit 222, it is controlled not to reproduce the accessory content automatically before reproduction of the main content.

Thereby, if the BD-ROM 104 is retrieved from the BD-ROM player 1 after writing the region code into the second storage unit, the user who inserts the BD-ROM 104 into the BD-ROM player 1 again can watch the main content immediately as far as the second storage unit 222 has not been initialized.

In other words, if the second storage unit 222 has been initialized, the accessory content is always automatically reproduced before reproduction of the main content, which is inconvenient for the user.

As explained above, by controlling reproduction of the accessory content depending on existence of the region code in the second storage unit 222, it is possible to prevent the second storage unit 222 from being initialized after writing the region code into the second storage unit 222, thereby increasing a possibility of performing the invariance judgment processing for the region code.

It should be noted that the same advantages can be obtained also by storing, into the second storage unit 222, information which should not be deleted for user's convenience, such as information indicating a position until which the main content has been reproduced.

Here, the control for the writing the information into the second storage unit 222, the reproducing of the accessory content, and the like are realized by the BD reproduction program which causes the program execution unit 222 to execute these processing.

It is also possible that, in addition to the main content such as a movie, a special content, such as a movie-making video regarding the movie, which is a special free offer for a user of the BD-ROM 104 is also recorded on the BD-ROM 104, and the special content is used as a content for preventing the second storage unit 222 from being initizalized, for example.

For example, when the BD-ROM 104 is inserted into the BD-ROM player 1 at the first time, in other words, if any region code is not stored in the second storage unit 222, such a special content is not appeared on a menu screen or the like thereby prohibiting reproduction of the special content. More specifically, description is given in the BD reproduction program to generate such a menu screen.

On the other hand, if the region code is stored in the second storage unit 222, in other words, if the second storage unit 222 has not been initialized since the region code had been written into the second storage unit 222, the program execution unit 206 is controlled to reproduce the main content and the special content.

For example, the program execution unit 206 generates a menu screen including a button or the like for reproduction of the special content.

Thereby, when the user retrieves the BD-ROM 104 from the BD-ROM player 1 after the region code is written into the second storage unit and then inserts the BD-ROM 104 into the BD-ROM player 1 again, the user can watch the special content as far as the second storage unit 222 is not initialized.

This means that the user can receive the special offer by not initializing the second storage unit 222. Therefore, by using such a special content as described above, it is also possible to prevent the user from initializing the second storage unit 222, which increases a possibility of performing the invariance judgment processing for the region code.

It should be note that, with reference to FIGS. 34 and 35, the invariance judgment processing for a region code, in other words, processing of determining whether or not the region code is the same as the previously setting region code, has been described. However, the same advantages can be obtained not only by judging invariance of the region code, but also by judging whether or not the region code itself stored in the first storage unit 221 is a regulated code which is defined by a standard and then changing subsequent processing depending on a result of the judgment.

Next, processing (authorization judgment processing) of judging whether or not the region code is a regulated region code is described.

In a certain BD-ROM player, if a not-regulated value is stored as SPRM(20), in other words, if a region code is not a regulated value, a content in association with a region to which the BD-ROM player belongs is prohibited from being reproduced. However, there is a possibility that a content which is not for the region can be reproduced by error.

The following describes a BD reproduction program for judging whether or not a region code stored in the BD-ROM player 1 is a regulated value, in order to prevent the above situation.

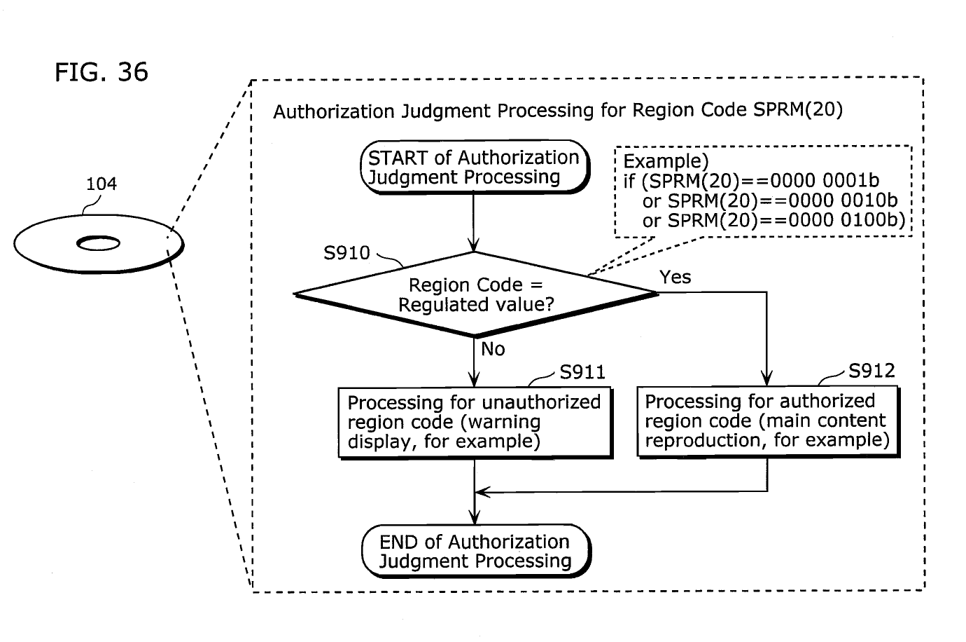

FIG. 36 is a flowchart of processing performed by the BD reproduction program for judging authorization of the region code and then controlling the BD-ROM player 1 based on a result of the judgment.

When the BD-ROM 104 is inserted, the BD-ROM player 1 reads out the BD reproduction program from the BD-ROM 104. Then, the BD reproduction program is executed to perform different content reproduction processing depending on whether or not the region code is a regulated value. Details of the processing is described below.

The program execution unit 206 reads out a value of SPRM(20) from the first storage unit 221, and compares the value with a predetermined regulated value (S910).

Here, it is assumed that “0000 0001b”, “0000 0010b”, and “0000 0100b” shown in FIG. 32 are regulated values, in other words, these values are defined as possible values for a region code.

In this case, the BD reproduction program has description as shown in FIG. 36. If the value of SPRM(20) is one of these three values such as “0000 0001b” (Yes at S910), then the value of SPRM(20), namely the region code, is a regulated value.

In this case, the program execution unit 206 controls the reproduction unit 220 to reproduce a main content in association with the region code, for example (S912).

On the other hand, If the region code is not any one of these regulated three values, then the region code is an unauthorized region code.

In this case, the program execution unit 206 does not reproduce the main content, but reproduces an image content displayed as characters “Since the region code is not a regulated region code, Title#1 is prohibited from being reproduced” for example, an audio content for conveying the same message by sound, or the like (S911).

As described above, if a region code stored in the first storage unit 221 is not a regulated value, it is possible to prevent the main content from being reproduced based on the region code.

Moreover, such authorization judgment processing for a region code is realized by the BD reproduction program recorded on the BD-ROM 104. Therefore, a content provider can decide when the authorization judgment processing is to be performed, which values are to be regulated values, and the like.

It should be noted that, with reference to FIG. 36, only the authorization judgment processing for a region code has been described. However, the BD reproduction program may cause the BD-ROM player 1 to execute the authorization judgment processing in addition to the series of steps of FIG. 34.

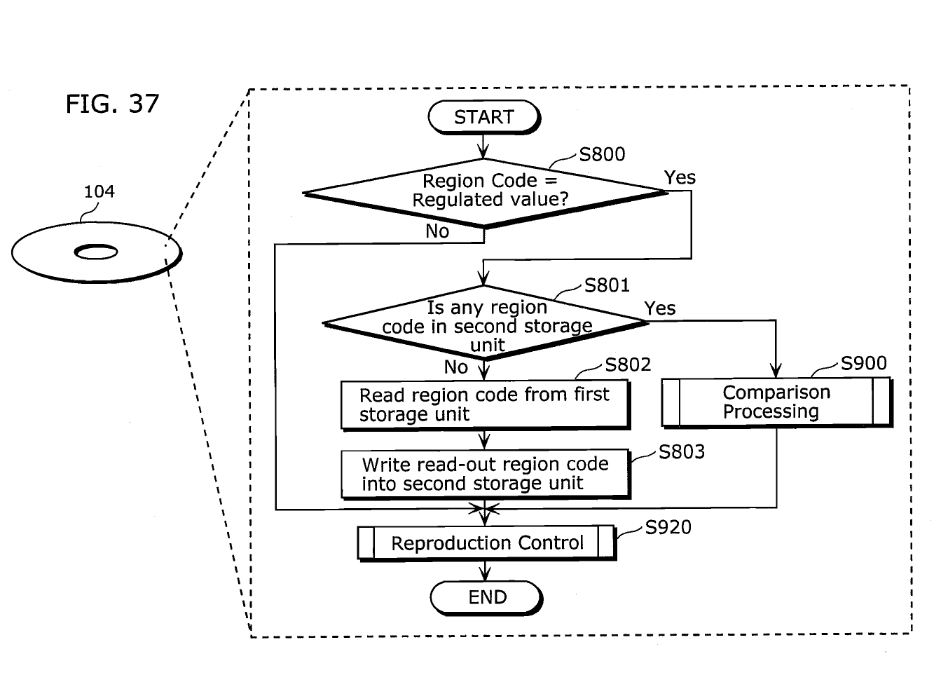

FIG. 37 is a Flowchart of one example of processing executed by the BD reproduction program for performing the authorization judgment processing for a region code before the invariance judgment processing for the region code. The following describes mainly characteristic processing with reference to FIG. 37.

The program execution unit 206 reads out a region code, namely a value of SPRM(20), from the first storage unit 221, and judges whether or not the region code is a regulated value (S800).

If the region code is a regulated value (Yes at S800), the program execution unit 206 confirms whether or not any region code is stored in the second storage unit 222 as described previously with reference to FIG. 34 (S801), and subsequent steps are the same as the steps of FIG. 34.

On the other hand, if the region code stored in the first storage unit 221 is not a regulated value (No at S800), then the above confirmation (S801) is not performed, but the program execution unit 206 controls content reproduction (S920).

In more detail, since the region code is not a regulated value, the program execution unit 206 controls the reproduction unit 220 not to reproduce the main content as described previously. In addition, the program execution unit 206 controls the reproduction unit 220 to reproduce an image content or the like for notifying a user of that the main content is prohibited from being reproduced.

As described above, by performing the authorization judgment processing for the region code prior to the invariance judgment processing for the region code (Steps S801, S900, and others), it is possible to prevent occurrence of unnecessary processing such as the invariance judgment processing for an unauthorized region code.

It should be noted that the BD reproduction program may perform the authorization judgment processing for a region code during the invariance judgment processing (S900).

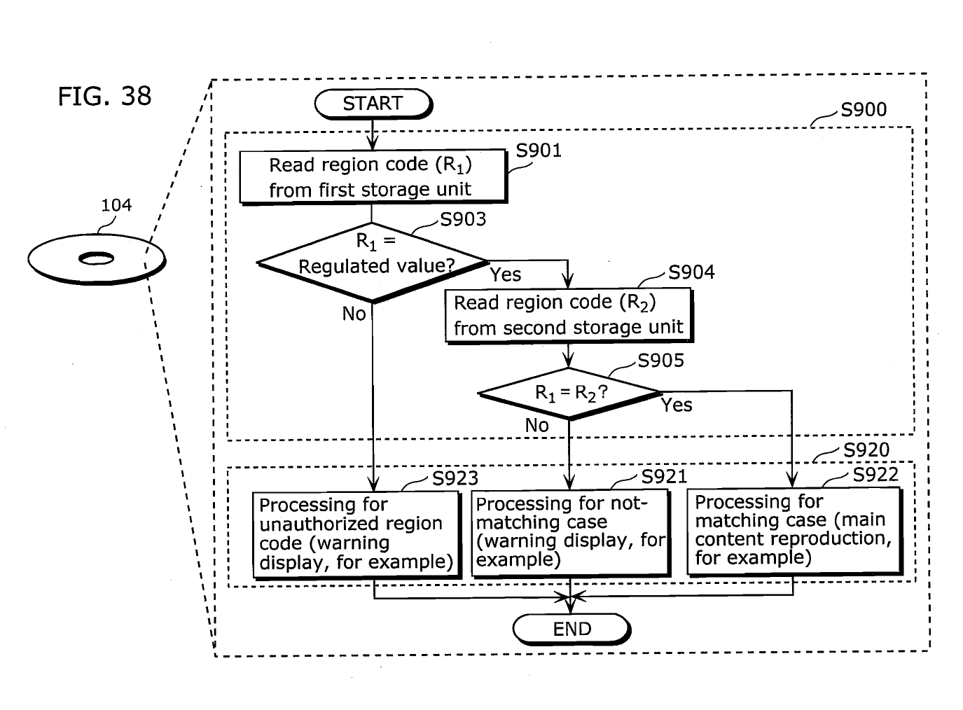

FIG. 38 is a flowchart of one example of processing executed by the BD reproduction program for performing the authorization judgment processing for a region code during the invariance judgment processing for the region code.

That is, FIG. 38 shows one example of a flow in which the processing of FIG. 35 includes the authorization judgment processing for a region code. The following describes mainly characteristic processing with reference to FIG. 38.

The program execution unit 206 reads out a region code (R₁) from the first storage unit 221, and judges whether or not the read-out region code R₁ is a regulated value (S903).

If the judgment is made that the region code R₁ is not a regulated value (No at S903), then the program execution unit 206 controls the reproduction unit 220 not to reproduce a main content. In addition, the program execution unit 206 controls the reproduction unit 220 to reproduce an image content or the like for notifying a user of that the main content is prohibited from being reproduced (S923).

Then, if the judgment is made that the region code R₁ is a regulated value (Yes at S903), a region code R₂ is read out from the second storage unit 222 (S904).

After that, as described with reference to FIG. 35, R₁ is compared with R₂ (S905), and processing for reproducing a content is performed based on whether or not R₁ is the same as R₂ (S921 or S922).

As described above, it is also possible to give description in the BD reproduction program to cause the BD-ROM player 1 to perform the invariance judgment processing and the authorization judgment processing for a region code.

In addition, an order of processing the invariance judgment processing and the authorization judgment processing is not always the order of FIG. 37 or FIG. 38. For example, the BD-ROM player 1 may perform the authorization judgment processing after the invariance judgment processing (S900).

In any order, only when a region code in the first storage unit 221, namely a value of SPRM(20), has not been changed and is a regulated value, content reproduction is performed properly based on the region code.

As described above, on the BD-ROM 104 according to the second embodiment, recorded is a BD reproduction program which causes the BD-ROM player 1 to perform processing regarding reproduction based on whether or not a recorded setting value is the same as a previously setting value.

More specifically, the program execution unit 206 which executes processing according to the BD reproduction program judges whether or not a value of SPRM(20) which is one of system parameters, namely a region code, is the same as a previously setting value. In addition, based on a result of the judgment, it is possible to decide whether or not the BD-ROM player 1 is allowed to reproduce a main content.

In other words, if a region code has been changed from a previously setting region code, it is possible to prevent that reproduction control for a content is performed based on the changed region code.

In other words, it is possible to cause the BD-ROM player 1 to perform reproduction control for a content based on a proper region code which has been initially set. Here, the BD reproduction program for realizing such reproduction control can be created by a provider of the content and recorded on the BD-ROM 104.

Furthermore, in order to perform the judgment processing, each BD-ROM player has, as standard functions, [i] a function (program execution unit 206, for example) of executing the BD reproduction program, and [ii] the second storage unit 222 (hard-disc, for example) in which a value of SPRM(20) is stored. This means that the execution of the judgment processing does not need a hardware dedicated to the processing.

Therefore, the BD-ROM 104 according to the second embodiment can allow not only the BD-ROM player 1 according to the second embodiment but also any BD-ROM players to reproduce contents based on intention of providers of the contents.

In addition, it is also possible to judge whether or not a region code in the BD-ROM player 1 is a regulated value. Thereby, when a region code at a certain timing is not a regulated value, it is possible to prevent that a content is reproduced based on the non-regulated region code.

It should be noted that, prior to processing regarding reproduction of a main content, it is possible to perform both of the invariance judgment processing and the authorization judgment processing for a region code, or only one of them.

It should also be noted that, when both of the invariance judgment processing and the authorization judgment processing for a region code are performed, any of them may be performed prior to the other.

It should also be noted that, prior to the invariance judgment processing and the authorization judgment processing for a region code, it is possible to judge whether or not a main content recorded on the BD-ROM 104 is in association with the region code in the BD-ROM player 1, namely a value of SPRM(20).

For example, when a plurality of main contents are recorded on the BD-ROM 104 and none of them are in association with a value of SPRM(20), in the BD-ROM 104 has no main content to be reproduced.

In this case, the invariance judgment processing and the authorization judgment processing for a region code do not need. In other words, only when there is any main content to be reproduced, the invariance judgment processing and the authorization judgment processing for a region code are performed.

Thereby, when there is no main content to be reproduced, unnecessary processing such as the invariance judgment processing for a region code is not performed.

As described above, each processing for performing content reproduction properly is realized by the BD reproduction program created by a content provider, and the content provider can appropriately decide an order of performing these processing, in combination or by a single.

It should be note that it has been described in the second embodiment that, prior to writing of a region code stored in the first storage unit 221 into the second storage unit 222, the judgment is made as to whether or not any region code is stored in the second storage unit 222 (S801 of FIG. 34).

However, this judging may be skipped. For example, it is also possible to previously ensure a region in second storage unit 222 on which a plurality of region codes can be recorded, and sequentially add each region code stored in the first storage unit 221 into the region every time the BD-ROM 104 is inserted into the BD-ROM player 1.

Here, the comparison between the region codes (S905 of FIG. 35) is performed by comparing [i] a region code which has been firstly written into the second storage unit 222 with [ii] the region code stored in the first storage unit 221.

Such processing makes it possible to judge whether or not the region code stored in the first storage unit 221, namely a value of SPRM(20), has been changed from a previously setting value.

It should also be note that the timing of writing a region code stored in the first storage unit 221 into the second storage unit 222 is not limited to only once prior to starting the control (S920 of FIG. 34) for reproduction of a main content after inserting the BD-ROM 104 into the BD-ROM player 1.

For example, when the invariance judgment processing (S900 of FIG. 34) is made that a value of SPRM(20) has not been changed from a previously setting value, the value of SPRM(20) may also be written into the second storage unit 222.

It is also possible that [i] only when the confirmation (S801 of FIG. 34) is made that no region code is stored in the second storage unit 222, a value of SPRM(20) is written int other second storage unit 222, and [ii] when it is determined, every time a predetermined period such as a month has passed, whether or not a value of SPRM(20) has been changed from a previously setting value, and if the value of SPRM(20) has not been changed, then the value of SPRM(20) is written into the second storage unit 222.

In any of the above processing, a proper value of SPRM(20) which has not been changed from the previously setting value is written into the second storage unit 222, which does not affect the subsequently-performed invariance judgment processing.

It should also be note that the a plurality of BD-ROMs 104 may share the region code stored in the second storage unit 222.

For example, it is assumed that each of BD reproduction programs recorded on a BD-ROM 104a and a BD-ROM 104b, respectively, performs writing of a value of SPRM(20) into the same region in the second storage unit 222.

In this case, the BD reproduction program of the BD-ROM 104 can use the value of SPRM(20) which is written by the BD reproduction program of the BD-ROM 104a into the second storage unit 222.

For example, when the BD-ROM 104a is inserted into the BD-ROM player 1 prior to the BD-ROM 104b, the BD reproduction program of the BD-ROI 104a writes a value of SPRM(20) indicating a region code into the second storage unit 222.

Therefore, there is no need for the BD-ROM 104b to write a value of SPRM(20) into the second storage unit 222 after the BD-ROM 104b is inserted into the BD-ROM player 1 after the BD-ROM 104a, so that the invariance judgment processing (S900 of FIG. 34) is performed.

It should also be note that it is also possible that invariance in a system parameter except the SPRM(20) is judged and processing performed by the BD-ROM player 1 is controlled based on a result of the judgment.

It should also be note that it is also possible that invariance in one of various kinds of system parameters such as a region code is judged, and only when the parameter has been changed from a previously setting value, reproduction control is performed based on the parameter.

In other words, the setting value of the information recording medium according to the present invention is not limited to the region code, but any value can be used if the value is set as a system parameter in the reproduction apparatus and is inherently not changed.

Change in such a setting value indicates that the setting value is not a corrent value. Therefore, without any measures, reproduction permission/prohibition of a main content and selection of a main content to be reproduced are performed based on the incorrent setting value.

However, the BD reproduction program recorded on the BD-ROM 104 according to the second embodiment causes the program execution unit 206 to judge invariance in the setting value, and if the setting value has been changed, causes the reproduction unit 220 to control to prohibit a main content from being reproducing.

This makes it possible to prevent that the main content is reproduced based on the changed setting value.

### INDUSTRIAL APPLICABILITY

The information recording medium and the reproduction control method according to the present invention enable a content provider who provides a content such as movie, drama, or music to permit to reproduce the content properly based on intention of the content provider. Therefore, the present invention is useful as an information recording medium for supplying such a content widely and a reproduction control method for permitting to reproduce such a content properly.

1. An information recording medium on which [i] a first content that can be reproduced by a reproduction apparatus and [ii] a program that is executed by the reproduction apparatus are recorded:
wherein the reproduction apparatus including [i] a first storage unit in which a setting value set for the reproduction apparatus is stored, [ii] an execution unit configured to execute said program, and [iii] a second storage unit where the execution unit can read and write information, and
said program causes the execution unit to execute steps of:
writing the setting value stored in the first storage unit into the second storage unit;
comparing the setting value stored in the first storage unit to the setting value which has been written into the second storage unit; and
controlling the reproduction apparatus not to reproduce the first content, in the case where the comparing indicates that the setting value stored in the first storage unit is different from the setting value which has been written into the second storage unit.

2. The information recording medium according to claim 1,
wherein the setting value is a region code which is information for identifying a region to which the reproduction apparatus is to be distributed.

3. The information recording medium according to claim 2,
wherein in the controlling, the reproduction apparatus is controlled to reproduce the first content, in the case where the comparing indicates that the region code stored in the first storage unit is same as a region code which has been written into the second storage unit and the first content corresponds to the region code stored in the first storage unit.

4. The information recording medium according to claim 1,
wherein said program causes the execution unit to execute a further step of
confirming whether or not any setting value is stored in the second storage unit, the confirming being performed prior to the writing of the setting value into the second storage unit, and
wherein in the writing of the setting value, the setting value stored in the first storage unit is written into the second storage unit, in the case where the confirming indicates that no setting value is stored in the second storage unit, and
in the comparing, the setting value stored in the second storage unit is compared to the setting value stored in the first storage unit, in the case where the confirming indicates that any setting value is stored in the second storage unit, the setting value stored in the second storage unit having been written into the second storage unit.

5. The information recording medium according to claim 4,
wherein in the writing of the setting value, the setting value stored in the first storage unit is not written into the second storage unit, in the case where the confirming indicates that any setting value is stored in the second storage unit.

6. The information recording medium according to claim 4,
wherein a special content is further recorded on said information recording medium as a special offer for a user of said information recording medium, and
in the controlling, the reproduction apparatus is controlled to reproduce the first content and the special content, in the case where the confirming indicates that any setting value is stored in the second storage unit and the comparing indicates that the setting value stored in the first storage unit is same as the setting value stored in the second storage unit.

7. The information recording medium according to claim 4,
wherein an accessory content is further recorded on said information recording medium,
said accessary content is not essential for said information recording medium, while the first content is essential for said information recording medium, and
in the controlling, the reproduction apparatus is controlled to reproduce the first content after reproducing the accessary content, in the case where the confirming indicates that any setting value is not stored in the second storage unit.

8. The information recording medium according to claim 1,
wherein the setting value stored in the first storage unit is a predetermined possible value,
said program causes the execution unit to execute a further step of judging whether or not the setting value stored in the first storage unit is the predetermined possible value, and
in the controlling, the reproduction apparatus is controlled not to reproduce the first content, in the case where the comparing indicates that the setting value stored in the first storage unit is not the predetermined possible value.

9. The information recording medium according to claim 1,
wherein a second content is further recorded on said information recording medium, the second content notifying a user of the reproduction apparatus of that the first content is not reproduced, and
in the controlling, the reproduction apparatus is controlled to reproduce the second content, in the case where the reproduction apparatus is controlled not to reproduce the first content.

10. The information recording medium according to claim 1,
wherein said program causes the execution unit to execute a further step of further writing the setting value stored in the first storage unit into the second storage unit, in the case where the comparing indicates that the setting value stored in the first storage unit is same as the setting value which has been written into the second storage unit.

11. The information recording medium according to claim 1,
wherein the second storage unit is one of a hard disc and a nonvolatile memory.

12. A reproduction apparatus which reproduces a content store in an information recording medium,
wherein a program executed by said reproduction apparatus is recorded on the information recording medium,
said reproduction apparatus comprising: [i] a first storage unit in which a setting value set for said reproduction apparatus is stored, [ii] an execution unit configured to execute the program; and [iii] a second storage unit where said execution unit can read and write information,
wherein said execution unit is configured to read and cause the program to execute steps of:
writing the setting value stored in said first storage unit into said second storage unit;
comparing the setting value stored in said first storage unit to the setting value which has been written into said second storage unit; and
controlling said reproduction apparatus not to reproduce the first content, in the case where the comparing indicates that the setting value stored in said first storage unit is different from the setting value which has been written into said second storage unit.

13. A reproduction control method of controlling reproduction of a content in a reproduction apparatus which reproduces the content recorded on an information recording medium,
on the information recording medium being recorded a program executed by the reproduction apparatus, and
the reproduction apparatus including: a first storage unit in which a setting value set for the reproduction apparatus is stored;
an execution unit configured to execute the program; and a second storage unit which the execution unit reads information from and writes information into,
said reproduction control method comprising steps which are executed by the execution unit according to the program:
writing the setting value stored in the first storage unit into the second storage unit;
comparing the setting value stored in said first storage unit to the setting value which has been written into the second storage unit; and
controlling the reproduction apparatus not to reproduce the first content, in the case where said comparing indicates that the setting value stored in the first storage unit is different from the setting value which has been written into the second storage unit.

14. A program which is executed by a reproduction apparatus that reproduces a content recorded on an information recording medium,
the reproduction apparatus including: a first storage unit in which a setting value set for the reproduction apparatus is stored;
an execution unit operable to execute the program; and a second storage unit where the execution unit can read and write information,
said program causing the execution unit to execute steps of:
writing the setting value stored in the first storage unit into the second storage unit;
comparing the setting value stored in said first storage unit to the setting value which has been written into the second storage unit; and
controlling the reproduction apparatus not to reproduce the first content, in the case where said comparing indicates that the setting value stored in the first storage unit is different from the setting value which has been written into the second storage unit.
